(19) United States
(12) Patent Application Publication
(10) Pub. No.: US 2022/0092738 A1
(43) Pub. Date: Mar. 24, 2022

(54) METHODS AND APPARATUS FOR SUPER-RESOLUTION RENDERING

(71) Applicant: Intel Corporation, Santa Clara, CA (US)

(72) Inventors: Yan Pei, Austin, TX (US); Ke Ding, San Jose, CA (US); Swarnendu Kar, Portland, OR (US); Selvakumar Panneer, Portland, OR (US); Mrutunjayya Mrutunjayya, Hillsboro, OR (US)

(21) Appl. No.: 17/359,142

(22) Filed: Jun. 25, 2021

Related U.S. Application Data
(60) Provisional application No. 63/116,035, filed on Nov. 19, 2020.

(51) Int. Cl. G06T 3/40; G06T 7/90; A63F 13/355

(52) U.S. Cl. CPC G06T 3/4053; G06T 3/4046; G06T 7/90; G06T 3/4092; A63F 2300/538; G06T 2207/10024; G06T 2207/10028; G06T 2207/20084; A63F 13/355

(57) ABSTRACT

Methods, apparatus, systems and articles of manufacture are disclosed for super-resolution rendering. An example apparatus includes a data handler to generate a multi-sample control surface (MCS) frame based on a color frame, a feature extractor to obtain features from the color frame, a depth frame, and the MCS frame, a network controller to generate spatial data and temporal data based on the features, and a reconstructor to generate a high-resolution image based on the features, the spatial data, and the temporal data.

### RELATED APPLICATION

This patent claims the benefit of U.S. Provisional Patent Application No. 63/116,035, which was filed on Nov. 19, 2020. U.S. Provisional Patent Application No. 63/116,035 is hereby incorporated herein by reference in its entirety. Priority to U.S. Provisional Patent Application No. 63/116,035 is hereby claimed.

### FIELD OF THE DISCLOSURE

This disclosure relates generally to frame rendering, and, more particularly, to methods and apparatus for super-resolution rendering.

### BACKGROUND

Super-resolution can be applied to images to reduce computational cost. For example, a frame is rendered at a lower resolution and up-sampled to a target resolution.

### BRIEF DESCRIPTION OF THE DRAWINGS

FIG. 1A is a schematic illustration of an example client rendering environment.

FIG. 1B is a schematic illustration of an example cloud rendering environment.

FIG. 2 is a block diagram representative of an example super-resolution controller of the example rendering environments of FIGS. 1A-1B.

FIG. 3 is a block diagram of an example super-resolution architecture, which may be used to implement the super-resolution controller of FIGS. 1A, 1B, and 2.

FIG. 4 is an example rasterization system, which may be used to implement the data handler of FIG. 2.

FIG. 5 illustrates example frames.

FIG. 6 shows results of a comparative runtime analysis of FIGS. 2 and/or 3 of example frameworks.

FIG. 7 shows results of a comparative quality analysis of FIGS. 2 and/or 3 of example frameworks.

FIG. 8 shows results of a network ablation analysis of FIGS. 2 and/or 3.

FIG. 9 is a flowchart representative of example machine readable instructions that may be executed by example processor circuitry to implement the example super-resolution controller of FIGS. 1-3 for super-resolution rendering.

FIG. 10 is a flowchart representative of example machine readable instructions that may be executed by example processor circuitry to implement the example data handler of FIG. 2 to generate frame sets.

FIG. 11 is a flowchart representative of example machine readable instructions that may be executed by example processor circuitry to implement the example feature extractor of FIGS. 2 and/or 3 to extract features from an input frame set.

FIG. 12 is a flowchart representative of example machine readable instructions that may be executed by example processor circuitry to implement the example network controller of FIGS. 2 and/or 3 to generate spatial data and/or temporal data.

FIG. 13 is a flowchart representative of example machine readable instructions that may be executed by example processor circuitry to implement the example reconstructor of FIGS. 2 and/or 3 to generate a high-resolution image.

FIG. 14 is a block diagram of an example processing platform including processor circuitry structured to execute machine readable instructions represented by the flowcharts of FIGS. 9-13 to implement the example super-resolution controller of FIGS. 1-3 for super-resolution rendering.

FIG. 15 is a block diagram of an example software distribution platform (e.g., one or more servers) to distribute software (e.g., software corresponding to the example machine readable instructions of FIGS. 9-13) to client devices as associated with end user and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 16 illustrates an example color frame and an example multiple-sample control surface (MCS) frame.

FIG. 17 is a block diagram of an example implementation of the processor circuitry of FIG. 14.

FIG. 18 is a block diagram of another example implementation of the processor circuitry of FIG. 14.

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

The demand for increased quality and throughput of real-time rendering is becoming increasingly challenging due to an increase in display resolution and higher refresh rates. Regardless of the increase in hardware acceleration support, these challenges continue to grow as applications, such as games, demand graphic hardware to handle rendering, artificial intelligence (AI), game physics, media in real-time, etc. Super-resolution techniques may reduce computational costs by rendering a frame at a lower resolution and up-sampling to a target resolution. However, due to fundamental differences between real images and rendered content, super-resolution for real images cannot be applied to real-time rendering.

Deep learning-based quality improvements in real time rendering can be used to solve the growing need of better gaming experiences on client devices. To achieve better gaming experiences with lower response time, game engines use the Graphics Processing Unit (GPU) to render a frame before subsequent refresh cycles. In some examples, game engines can take advantage of AI accelerators in the GPU to render frames at lower resolutions and use AI approaches to scale the frames to a desired resolution.

In recent years, the gaming industry has improved the gaming experience on devices using cloud computing technology. For example, in cloud gaming, deep learning-based quality enhancement provides a better gaming experience in low bandwidth conditions. For example, cloud computing can render the game frame at a low resolution and transmit the game frame to a client device, at which AI-based up-sampling is performed before presenting the game frame to the user.

In prior deep learning techniques, super-resolution tasks rely on the use of hand-crafted features with fixed super-resolution and/or anti-aliasing patterns. Currently, convolutional networks are the standard model for representing prior knowledge related to object appearances. Depending on the input type and target use case, super-resolution can be classified as (1) single image super-resolution (SISR), (2) video super-resolution (VSR), or (3) GPU-assisted super-resolution (GSR). For example, SISR is a quality driven algorithm. In SISR techniques, there is no prior knowledge other than a low-resolution image, which limits the quality improvement potentials. In examples of VSR, techniques access multiple frames to provide more contextual scene information from spatial-temporal inter-dependency and, thus, yield a higher quality rendering. Moreover, in some use cases of VSR, there are higher expectations such as temporal stability and real-time performance.

Examples disclosed herein are directed to GSR, a performance and quality-focused deep learning approach. Example GSR techniques interact directly with the GPU and game engine and process GPU rendered frames instead of image or video frames. In some examples, GSR techniques are coupled with two tasks: anti-aliasing and up-scaling. For example, GSR techniques perform anti-aliasing and up-scaling with better quality compared to traditional full resolution anti-aliasing only approaches. Thus, the game engine can support higher resolution through super-resolution. GSR takes advantage of a GPU's internal sub-pixel states to increase the quality of the output. In contrast to prior super-resolution techniques that warp and stack successive frames for temporal coherence, examples disclosed herein use convolutional long short-term memory (ConvLSTM) network and operate on one frame, due to GPU-generated motion vectors.

Examples disclosed herein better support client and cloud rendering scenarios for computer and network bandwidth constrained environments. For example, techniques disclosed herein are directed to render-aware super-resolution (RASR). Examples disclosed herein access RGB frame(s) and intermediate buffers in the GPU rendering pipeline to input into convolutional neural network(s). For example, the convolutional neural networks generate output features of the RGB frames and/or buffers. Examples disclosed herein also implement recurrent neural network architectures to preserve temporal coherence in adjacent frames. Examples disclosed herein further reconstruct a high resolution image based on the output features and temporal data.

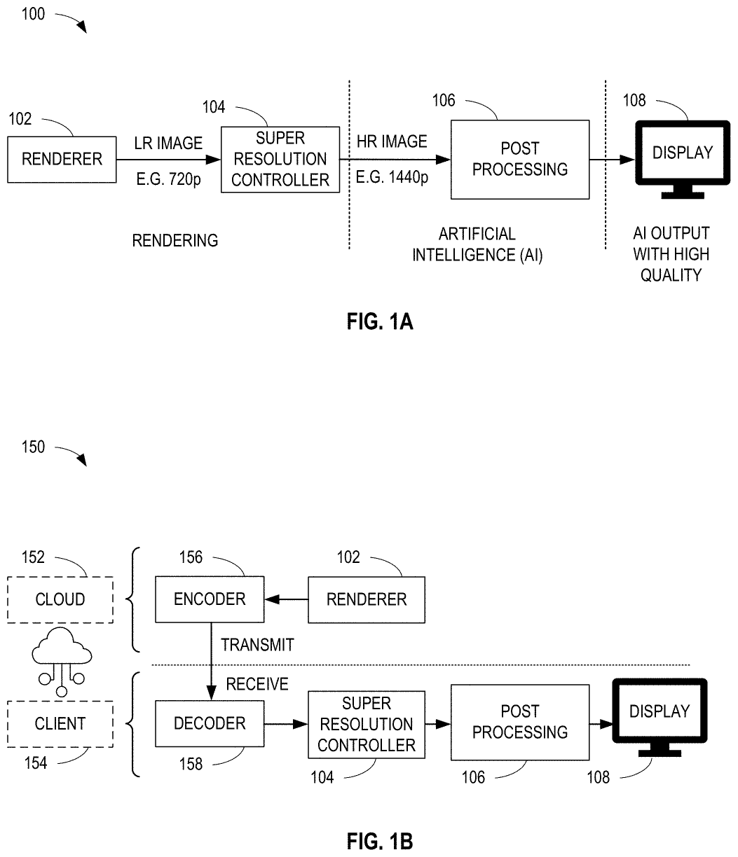

FIG. 1A is a schematic illustration of an example client rendering environment 100. The client rendering environment 100 includes an example renderer 102, an example super-resolution controller 104, an example post-processing controller 106, and an example display device 108. That is, compared to current client gaming pipelines, the super-resolution controller 104 is inserted between the renderer 102 and the post-processing controller 106.

The example renderer 102 generates low-resolution frames. For example, the renderer 102 generates an image with a display resolution of 720 pixels (p). The example super-resolution controller 104 obtains and up-samples the low-resolution image to generate a high-resolution image. That is, the example super-resolution controller 104 up-samples the 720p image to a target resolution. For example, the super-resolution controller 104 generates a high-resolution image with a display resolution of 1440p. However, the example renderer 102 and/or the example super-resolution controller 104 can generate images with a display resolution of 1080p, etc.

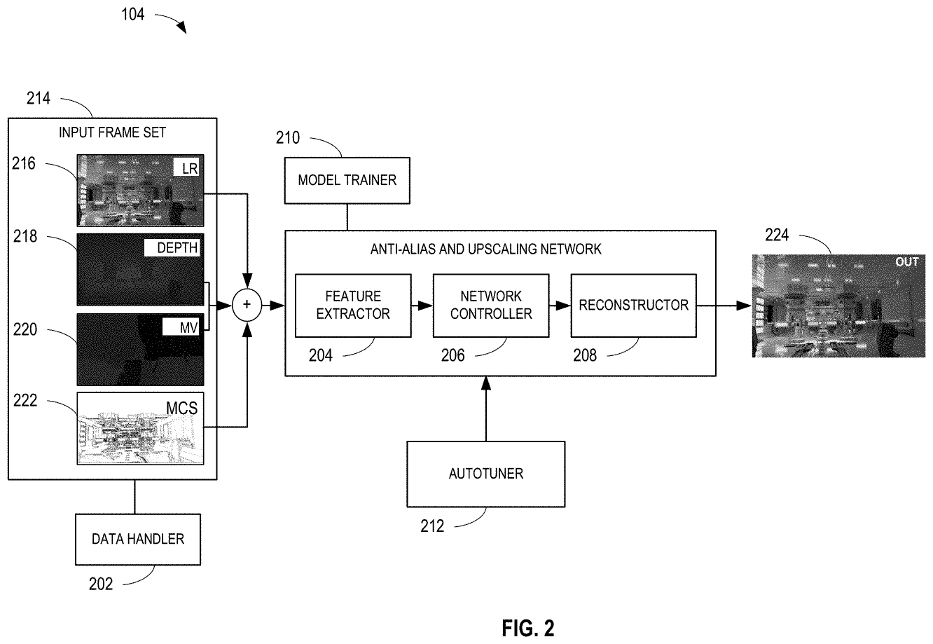

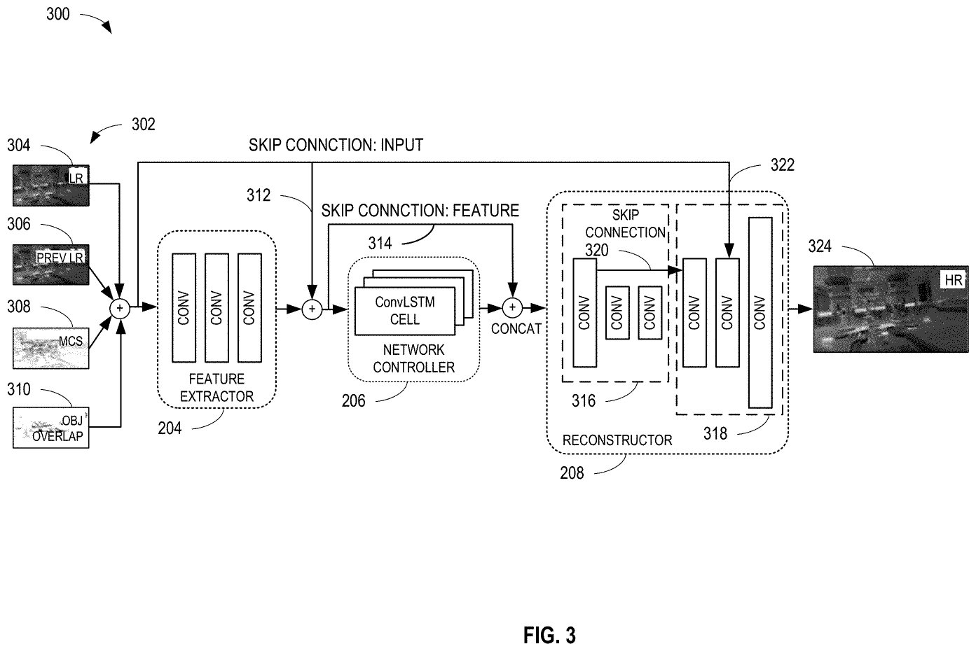

In examples disclosed herein, the super-resolution controller 104 obtains the low-resolution frames. In some examples, the low-resolution frames include an input frame set (e.g., a color frame, a depth frame, etc.). The example super-resolution controller 104 inputs the low-resolution frames into a first convolutional neural network to generate features. The example super-resolution controller 104 inputs the features into a recurrent neural network to generate temporal data. In some examples, the super-resolution controller 104 concatenates the low-resolution frames, the features, and/or the temporal data. The example super-resolution controller 104 inputs the temporal and/or motion data into a second convolutional neural network to generate the high-resolution image. The example super-resolution controller 104 is described below in connection with FIGS. 2-3.

The example post-processing controller 106 obtains the high-resolution image and displays the high-resolution image via the display device 108. In some examples, the post-processing controller 106 further processes the high-resolution image. For example, the post-processing controller 106 performs machine learning, artificial intelligence, etc. tasks on the high-resolution image (e.g., object detection, facial recognition, etc.). In some examples, the display device 108 is a desktop computer. The example display device 108 can additionally or alternatively be a laptop, a tablet, etc.

FIG. 1B is a schematic illustration of an example cloud rendering environment 150. In some examples, the cloud rendering environment 150 is a gaming environment. Thus, cloud computing enables the gaming industry (e.g., game developers, etc.) to implement a gaming experience on a wider range of devices (e.g., personal computers, etc.). The example cloud rendering environment 150 includes an example cloud environment 152 and an example client environment 154. For example, the cloud environment 152 can be implemented in a first location (e.g., a data center) and the client environment 154 can be implemented in a second location (e.g., a home of the user).

The example cloud environment 152 includes the example renderer 102 (FIG. 1A) and an example encoder 156. The example client environment 154 includes an example decoder 158, the example super-resolution controller 104 (FIG. 1A), the example post-processing controller 106 (FIG. 1A), and the example display device 108 (FIG. 1A). Thus, the above discussion of like numbered components in FIG. 1A apply equally well to the like numbered parts of FIG. 1B and, to avoid redundancy, the like numbered components of FIG. 1B will not be separately described.

The example encoder 156 of the cloud environment 152 obtains the low-resolution image generated by the example renderer 102. The example encoder 156 encodes the low-resolution image and transmits the encoded image to the client environment 154 (e.g., a client device). For example, the encoder 156 encodes the low-resolution image using a JPEG codec, a PNG codec, etc. Thus, the example cloud rendering environment 150 reduces network bandwidth requirements by transmitting frames of a lower resolution.

The example decoder 158 of the client environment 154 receives the encoded image from the encoder 156. The example decoder 158 decodes the encoded image to generate a decoded, low-resolution image. For example, the decoder 158 implements the same type of codec implemented by the encoder 156. As described above, the example super-resolution controller 104 up-samples the low-resolution image to a target resolution to generate a high-resolution image. The example display device 108 displays the high-resolution image.

FIG. 2 is a block diagram representative of the example super-resolution controller 104 of the example rendering environments 100, 150 of FIGS. 1A-1B. The example super-resolution controller 104 of FIG. 2 includes an example data handler 202, an example feature extractor 204, an example network controller 206, an example reconstructor 208, an example model trainer 210, and an example autotuner 212.

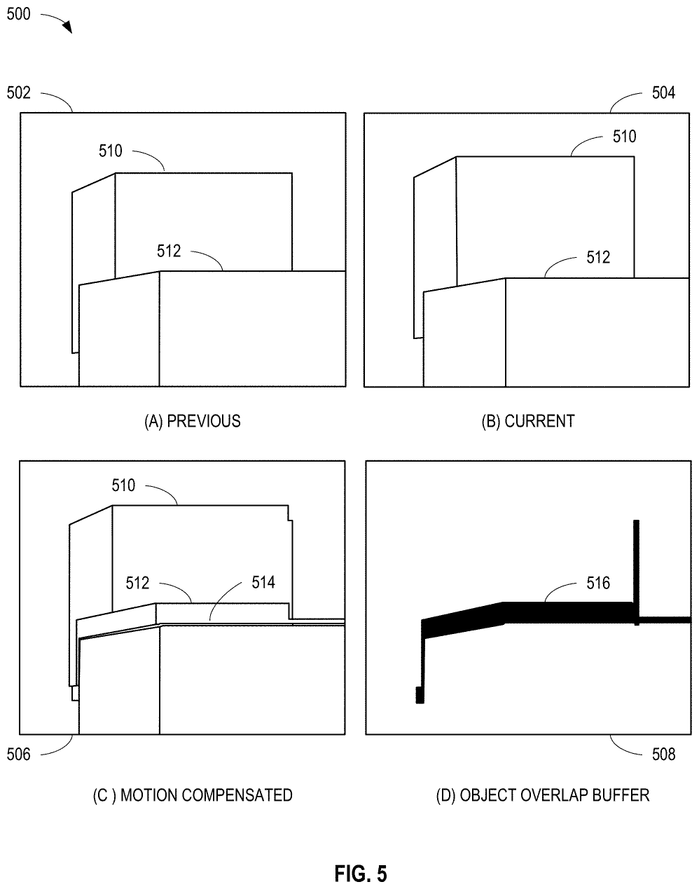

The data handler 202 generates an example input frame set 214. For example, the data handler 202 obtains the low-resolution image generated by the renderer 102 (FIG. 1). The low-resolution image includes an example color frame 216 and an example depth frame 218. The example color frame 216 includes color components (e.g., red-green-blue (RGB) components) of a pixel. The example depth frame 218 includes the pixel's depth, which refers to the distance of the pixel with a reference plane. In some examples, the data handler 202 also obtains a previous low-resolution image (not illustrated). For example, the previous low-resolution image corresponds to the image rendered at a prior time compared to the current image. In some examples, the data handler 202 generates a motion-compensated frame based on the current frame and the previous frame. For example, the data handler 202 performs backwards motion compensation on the previous frame. In response to determining the super-resolution controller 104 obtained a previous low-resolution image, the data handler 202 generates an example object overlap frame 220. The example object overlap frame 220 measures the coordinate offset of each pixel from one frame to another. The example data handler 202 compares the depth buffer of the current frame (e.g., the depth frame 218) to the depth buffer of the motion-compensated previous frame. If the depth of the pixels of the motion-compensated previous frame are smaller than the depth of the pixels of the current frame, the data handler 202 flags the corresponding pixel in the object overlap frame 220. However, in some examples, the input frame set 214 do not include the object overlap frame 220 (e.g., the data handler 202 did not obtain a previous image). The example object overlap frame 220 is described below in connection with FIG. 5.

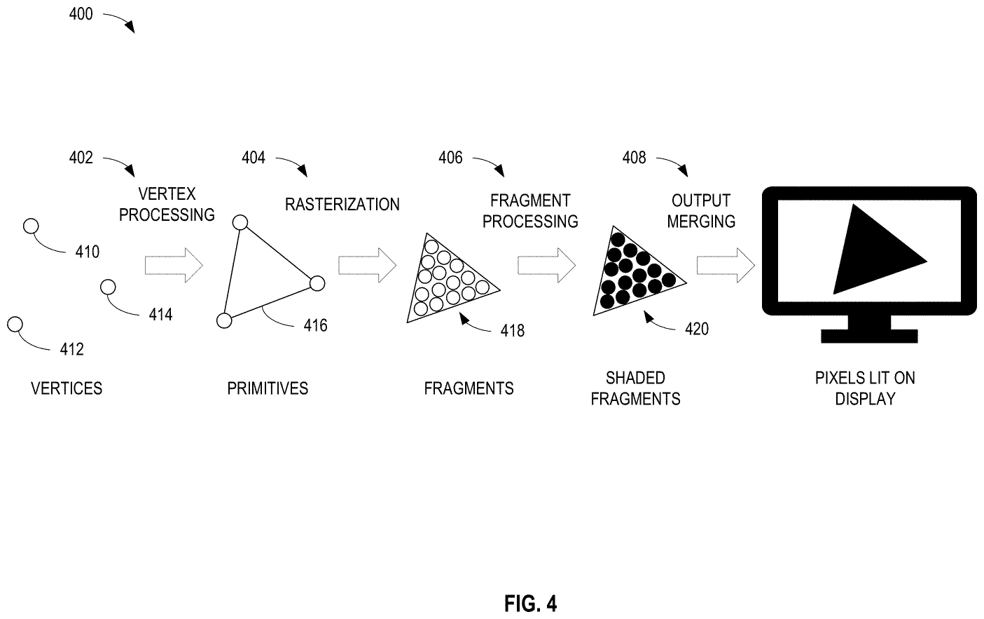

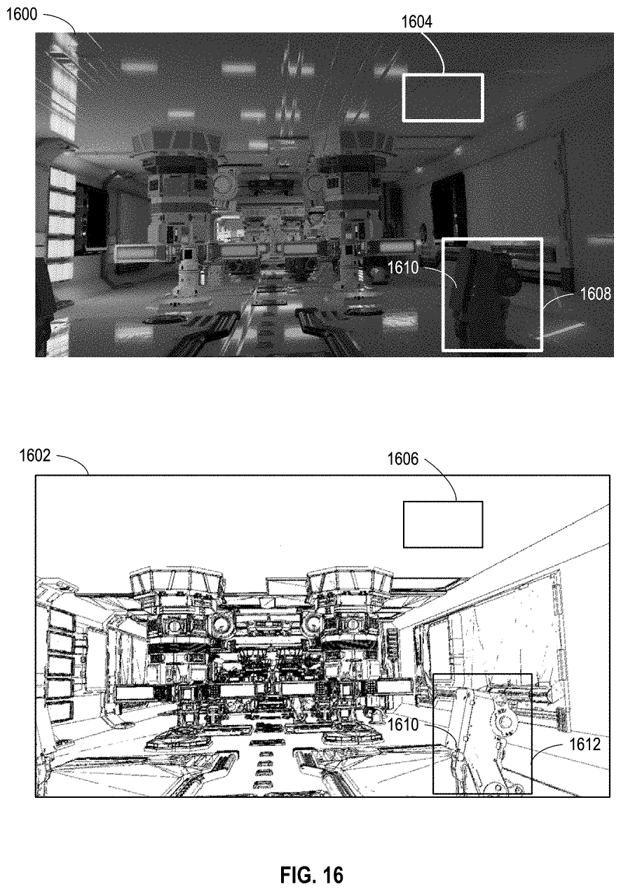

Additionally or alternatively, the example data handler 202 generates an example multi-sample control surface (MCS) frame 222. The example MCS frame 222 determines potential regions of aliasing. In some examples, the MCS frame 222 is a multi-sample anti-aliasing (MSAA) buffer based on rasterization. For example, the final color of a pixel is determined based on how samples in a pixel are rendered. Thus, pixels near object edges are likely to have different sample colors. Further, aliasing is usually noticeable at object edges. The example MCS frame 222 indicates potentially aliased regions by comparing the samples' colors within each pixel. For example, the data handler 202 segments the pixels of the current frame (e.g., the color frame 216) into samples. If the example data handler 202 determines that all of the samples of the pixel are the same color, the data handler 202 assigns white to the corresponding pixel of the MCS frame 222. If the example data handler 202 determines that the samples of the pixel are not the same color, the data handler 202 assigns black to the corresponding pixel of the MCS frame 222. Rasterization is described below in connection with FIG. 4. The example MCS frame 222 is described below in connection with FIG. 16.

The example feature extractor 204 extracts features of the input frame set 214. In examples disclosed herein, the feature extractor 204 generates learnable features. In some examples, the feature extractor 204 is implemented by a three-layer convolutional neural network. However, the example feature extractor 204 can include a greater or fewer number of layers. In some examples, the feature extractor 204 inputs the color frame 216, the depth frame 218, and the MCS frame 222 (e.g., no object overlap frame 220). Additionally or alternatively, the example feature extractor 204 inputs the color frame 216 (e.g., the current frame and the motion-compensated previous frame), the object overlap frame 220, and the MCS frame 222. The example feature extractor 204 concatenates the features with the input frame set 214.

The example network controller 206 determines spatial information and temporal information of the input frame set 214. For example, the network controller 206 obtains the features and/or the input frame set 214 (e.g., a concatenated output) from the feature extractor 204. In some examples, the network controller 206 is a recurrent neural network with 2D convolutional modules to preserve temporal coherence between adjacent frames. For example, the network controller 206 is a ConvLSTM network to merge historical features (e.g., learned features) with features of the current frames (e.g., the input frame set 214).

In some examples, the network controller 206 determines the input frame set 214 does not include the object overlap frame 220 and, thus, the input frame set 214 does not include previous frames and/or motion vectors (e.g., the color frame 216 is one frame corresponding to a first time). In such examples, the network controller 206 implements the recurrent neural network to preserve temporal coherence between adjacent frames (e.g., a first frame at a first time and a second frame at a second time). Additionally or alternatively, the network controller 206 determines the input frame set 214 includes the object overlap frame 220. That is, the example input frame set 214 includes one motion compensated previous frame (e.g., the color frame 216). The example network controller 206 inputs the input frame set 214 and/or the features generated by the feature extractor 204 through the recurrent neural network to generate spatial data and/or temporal data. The example network controller 206 concatenates the spatial data and/or the temporal data with the features extracted by the feature extractor 204.

The example reconstructor 208 generates an example high-resolution image 224 corresponding to the input frame set 214. In examples disclosed herein, the high-resolution image 224 has a higher resolution compared to the input frame set 214. In some examples, the reconstructor 208 is implemented by a convolutional neural network. For example, the reconstructor 208 is a UNet. In some examples, the reconstructor 208 is a UNet with skip connections. The example reconstructor 208 includes one or more encoder blocks to down-sample the features, the spatial data, and/or the temporal data to generate encoded data. The example reconstructor 208 includes one or more decoder blocks (e.g., corresponding to the number of encoder blocks) to decode the encoded data. That is, the one or more decoder blocks up-sample the features, the spatial data, and/or the temporal data. In some examples, the decoder blocks use bilinear interpolation to reduce computational costs. However, the decoder blocks can use deconvolution, etc. In examples disclosed herein, a residual of the input frame set 214 is applied via a skip connection to the final up-sampling layer of the reconstructor 208. In some examples, the residual improves the reconstruction quality of the high-resolution image 224. In some examples, the final up-sampling layer of the reconstructor 208 includes a squeeze-and-excitation network (SENET) to activate an attention mechanism. For example, the attention mechanism assigns different weights to the features, the spatial data, and/or the temporal data.

In examples disclosed herein, the UNet is an unbalanced UNet (e.g., the resolution of the input (e.g., the low resolution image) and output (e.g., the high resolution image) are not the same). In some examples, the down-sampling path (e.g., the encoder path) is reduced based on the up-sampling path (e.g., the decoder path). That is, the length of the encoding path is reduced based on a network up-sampling scale. For example, if the super-resolution up-sampling scale is two, one level of the down-sampling path in the reconstructor 208 is removed.

The example model trainer 210 trains a super-resolution model for the feature extractor 204, the network controller 206, and/or the reconstructor 208. The model trainer 210 defines a training loss, L, in example Equation 1.

L=0.5xLₛ+0.5x(1−ssim)+0.9xLₜ+0.1xLₚ Equation 1

The variable L_{S} is the spatial loss, the variable Lₜ is the temporal loss, the variable ssim is the structural similarity index, and the variable Lₚ is the perceptual loss. In some examples, the model trainer 210 determines Lₚ based on a pre-trained VGG19 network.

The example model trainer 210 obtains training data. In some examples, the training data includes 6,000 frames uniformly separated into 100 sequences (e.g., 60 frames per sequence). The example model trainer 210 pseudo-randomly selects 80 of the sequences to train the super-resolution model, 10 of the sequences for validation, and 10 of the sequences for inference. However, the model trainer 210 can use any number of frames and/or sequences to train the super-resolution model.

In some examples, the model trainer 210 renders the input low-resolution frames of the sequences at 1280×720p with 2×MSAA enabled. For ground truth images, the example model trainer 210 renders frames at 5120 ×2880p with 8×MSAA enabled and resizes the images to 2560×1440p using bilinear down-sampling. That is, the example model trainer 210 trains a 2×2 super-resolution model. In some examples, the model trainer 210 pseudo-randomly divides each input frame of the sequences into overlapped 128×128pixel patches during training and validation. The entire frame (e.g., 2560×1440p) is input into the network during inference. In examples disclosed herein, the super-resolution model is convolutional and, thus, can obtain frames of any resolution for inference.

The example autotuner 212 determines the hyper-parameters (e.g., network design parameters) of the super-resolution controller 104. In examples disclosed herein, the autotuner 212 is performance aware. For example, the autotuner 212 uses Sequential Model-based Bayesian optimization (SMBO) using the Tree of Parzen Estimators (TPE) algorithm and a median pruner in open source Optuna HPO framework to search for optimal network settings over a set of pre-defied parameters. An example hyper-parameter search space is illustrated in example Table 1.

TABLE 1

| Parameters | Range | | |
|---|---|---|---|
| Learning rate | (10⁻⁵, 10⁻³) | | |
| Weight decay | (0.8, 1.0) | | |
| Batch size | 2, 4, 8 | | |
| # of previous frames | 0, 1, 2, 3, 4 | | |
| FE layers | (32, 32, 8) | (32, 32, 12) | (32, 32, 16) |
| ConvLSTM cells | (48) | (32, 48) | (48, 64) |
| | (32, 32, 48) | (48, 48, 48) | (48, 48, 64) |
| UNet encoder | (96) | (128) | (64, 128) |
| | (128, 128) | (96, 192) | (128, 256) |

The learning rate, weight decay, and batch size parameters define the parameters used by the example model trainer 210 to train the super-resolution model. In some examples, the autotuner 212 selects a learning rate of 1×10⁻⁴, a weight decay of 0.9, and a batch size of four. In examples disclosed herein, the number of previous frames parameter defines the number of previous frames included in the input frame set 214. For example, the number of previous frames can be 0 (e.g., the object overlap frame 220 is not included in the input frame set 214). Additionally or alternatively, the number of previous frames is 1 (e.g., the input frame set 214 includes the object overlap frame 220), etc. Thus, the example autotuner 212 determines the number of previous frames based on the input frame set 214. The example FE layers parameter determines the number of kernels within each convolution layer of the feature extractor 204. For example, the autotuner 212 determines the first layer of the feature extractor 204 has 32 kernels, the second layer of the feature extractor 204 has 32 kernels, and the third layer of the feature extractor 204 has 8 kernels. The example ConvLSTM cells parameter determines the number of ConvLSTM cells stacked and the corresponding number of kernels of the cells of the network controller 206. The UNet encoder parameter determines the number of encoder stages and the corresponding number of kernels in the encoder phase of the example reconstructor 208. The example autotuner 212 determines the UNet decoder parameter based on the UNet encoder parameter (e.g., the same number of decoder stages).

FIG. 3 is a block diagram of an example super-resolution architecture 300, which may be used to implement the super-resolution controller 104 of FIGS. 1A, 1B, and 2. The example super-resolution architecture 300 includes the feature extractor 204, the network controller 206, and the reconstructor 208 of FIG. 2. The example data handler 202 (FIG. 2) obtains and/or generates an example input frame set 302. In the illustrated example of FIG. 3, the input frame set 302 includes an example first color frame 304, an example second color frame 306, an example MCS frame 308, and an example object overlap frame 310. That is, the example input frame set 302 includes a previous frame (e.g., the second color frame 306). Additionally or alternatively, the example input frame set 302 includes the first color frame 304, the MCS frame 308, and a depth frame (not illustrated). In such examples, the input frame set 302 does not include the second color frame 306 and the object overlap frame 310. The example data handler 202 (FIG. 2) concatenates the frames 304, 306, 308, 310 to generate the input frame set 302.

The example feature extractor 204 obtains the input frame set 302. In the illustrated example of FIG. 3, the convolutional neural network of the feature extractor 204 includes three layers. The example feature extractor 204 generates learnable features based on the input frame set 302 and concatenates the features with the input frame set via an example first skip connection 312. That is, the example feature extractor 204 generates a first concatenated output.

The example network controller 206 obtains the first concatenated output generated by the feature extractor 204 (e.g., the input frame set 302 and the features). In the illustrated example of FIG. 3, the network controller 206 includes three ConvLSTM cells. However, the example network controller 206 can include a greater or fewer number of ConvLSTM cells. The example network controller 206 inputs the first concatenated output into the ConvLSTM cells to generate spatial data and/or temporal data. The example network controller 206 concatenates the temporal data with the first concatenated output to generate a second concatenated output via an example second skip connection 314. For example, the second concatenated output includes the input frame set 302, the features, the spatial data, and the temporal data.

The example reconstructor 208 obtains the second concatenated output generated by the network controller 206. In the illustrated example of FIG. 3, the reconstructor 208 includes example encoder blocks 316 and example decoder blocks 318. For example, the encoder blocks 316 include three blocks and the decoder blocks 318 include three blocks. However, the example reconstructor 208 can include a fewer or greater number of the encoder blocks 316 and the decoder blocks 318. The example reconstructor 208 includes an example third skip connection 320. For example, the first bock of the encoder blocks 316 generates and transmits down-sampled data to the first block of the decoder blocks 318 via the third skip connection 320. The super-resolution architecture 300 includes an example fourth skip connection 322. For example, the data handler 202 transmits a residual of the first color frame 304 and/or the second color frame 306 to the second block of the decoder blocks 318 via the fourth skip connection 322. The third block of the decoder blocks 318 outputs an example high-resolution image 324 (e.g., the high-resolution image 224 of FIG. 2). That is, the example decoder blocks 318 up-sample the frames to a target resolution to generate the high-resolution image 324.

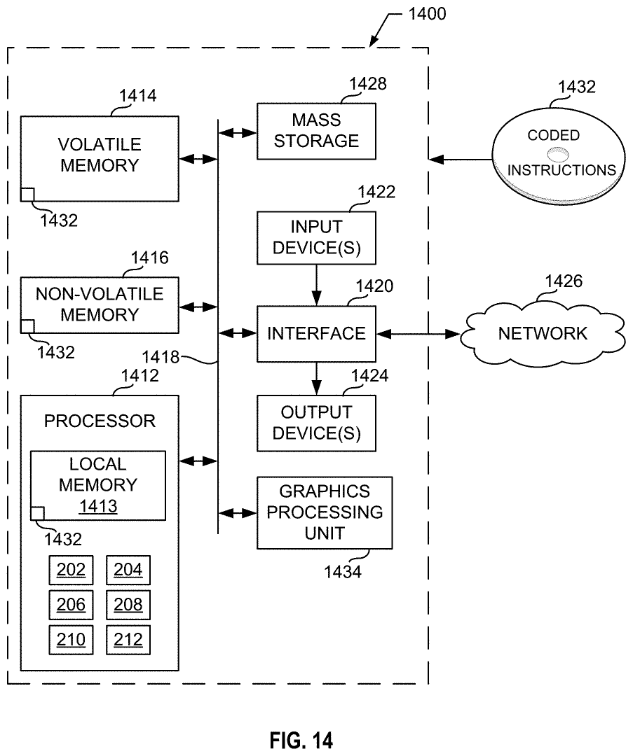

FIG. 4 is an example rasterization system 400, which may be used to implement the data handler 202 of FIG. 2. As described above, real-time graphics applications rely on rasterization to perform real-time rendering using a GPU (e.g., the example GPU 1434 of FIG. 14). For example, in 3D games, rasterization enables execution of shaders (e.g., kernel programs) at various stages of the 3D pipeline (e.g., vertex, geometry, samples, pixel, etc.). The time to render a frame depends on the number of invocations of the shaders for each object and the length of the shader.

The example rasterization system 400 includes an example vertex processing stage 402, an example rasterization stage 404, an example fragment processing stage 406, and an example output merging stage 408. During the example vertex processing stage 402, the GPU identifies an example first vertex 410, an example second vertex 412, and an example third vertex 414. The GPU generates an example primitive 416 based on the vertices 410, 412, 414. The example primitive 416 is a triangle.

During the example rasterization stage 404, the GPU generates example fragments 418. For example, the GPU segments the primitive 416 into the fragments 418. The GPU can rasterize 1×, 2×, 4×, 8×, 16×, etc. samples within one pixel. In some examples, the application can set the sample positions within pixels before rendering.

During the example fragment processing stage 406, the GPU generates example shaded fragments 420. For example, the GPU shades the fragments 418 to generate the shaded fragments 420. In some examples, the GPU generates MCS frames (e.g., the MCS frame 222 of FIG. 2 and/or the MCS frame 308) based on the shaded fragments. For example, the shaded fragments 420 are the same color. Therefore, the example data handler 202 (FIG. 2) determines the corresponding pixel of the primitive 416 in the MCS frame is white. However, if one or more of the example shaded fragments 420 are different colors, the example data handler 202 determines the corresponding pixel of the primitive 416 in the MCS frame is black. During the example output merging stage 408, the GPU displays pixels on a display (e.g., the display device 108 of FIG. 1). For example, the GPU determines which pixels to luminate on the display based on the shaded fragments 420.

FIG. 5 illustrates example frames 500. The example frames 500 include an example first color frame 502, an example second color frame 504, an example third color frame 506, and an example object overlap frame 508. In the illustrated example of FIG. 5, the first color frame 502 and the second color frame 504 are subsequent color frames (e.g., the first color frame 502 corresponds to a first time and the second color frame 504 corresponds to a second time). For example, the second color frame 504 is the current frame and the first color frame 502 is the previous frame. In the illustrated example of FIG. 3, the third color frame 506 is a motion compensated color frame.

The example color frames 502, 504, 506 include an example first object 510 and an example second object 512. In some examples, the first object 510 is a first color (e.g., green) and the second object 512 is a second color (e.g., red). The example first object 510 moves vertically upwards in the second color frame 504 with respect to the first color frame 502. That is, pixels corresponding to the first object 510 are visible in the second color frame 504 but are not visible in the first color frame 502 (e.g., the pixels are covered by pixels of the second object 512 in the first color frame 502).

In the illustrated example, when the GPU performs backwarping on the first color frame 502 to generate the motion compensated color frame (e.g., the third color frame 506), the upward motion of the pixels corresponding to the first object 510 are applied to the pixels corresponding to the second object 512, generating an example artifact 514. The example artifact 514 becomes worse (e.g., becomes bigger, more visible, etc.) when the GPU recursively compensates previous frames artifacts (e.g., the artifacts accumulate and propagate). Because the GPU mistakenly applies the motion vector of the first object 510 to the second object 512, the pixels in the motion-compensated frame (e.g., the third color frame 506) have smaller depth values than the corresponding pixels of the actual current frame (e.g., the second color frame 504). Thus, the GPU generates the example object overlap frame 508 based on a comparison of the depth frame of the current frame (e.g., corresponding to the second color frame 504) and the motion-compensated depth frame of the previous frame (e.g., corresponding to the third color frame 506). The example object overlap frame 508 includes an example overlap region 516. The GPU generates the example overlap region 516 in response to identifying pixels with smaller depth values based on the comparison of the depth frames corresponding to the color frames 504, 506.

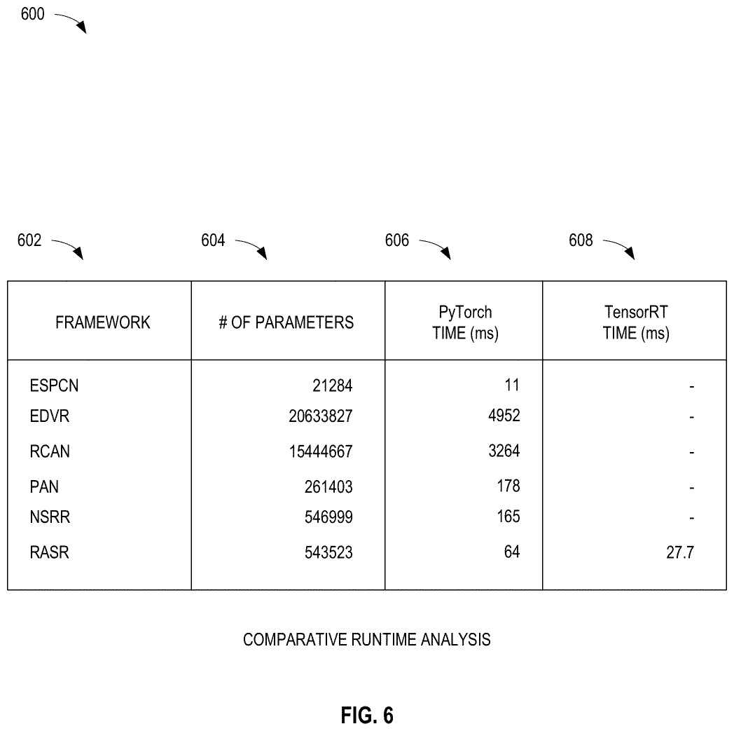

FIG. 6 shows results of a comparative runtime analysis 600 of FIGS. 2 and/or 3 of example frameworks 602. The comparative runtime analysis 600 includes example parameters 604, example PyTorch platform runtimes 606, and example TensorRT platform runtimes 608. The frameworks 602 include example super-resolution frameworks. For example, the frameworks 602 include SISR frameworks (e.g., PAN, RCAN), VSR frameworks (e.g., ESPCN, EDVR), SRR frameworks (e.g., NSRR), and the example techniques disclosed herein (e.g., RASR). The number of parameters 604 corresponds to the model size of the frameworks 602. The PyTorch platform runtimes 606 correspond to the inference time for the frameworks 602 when processed on a PyTorch platform. A PyTorch platform is an open source machine learning library used for computer vision applications, natural language processing applications, etc.

In the illustrated example of FIG. 6, the PyTorch platform runtimes 606 are the inference time for one full frame. For example, the RASR framework has a shorter runtime than the EDVR framework and the RCAN framework due to the larger model sizes (e.g., the number of parameters 604) of the latter frameworks. Compared to the RASR framework, the PAN framework has approximately 50% less parameters but a longer inference time due to reduced parallelism. In the illustrated example of FIG. 6, the NSRR framework has a longer runtime compared to RASR due to a large portion of the NSRR framework's computation operating in the target-resolution space (e.g., 2560×1440p, etc.) instead of the low-resolution space (1280×720p, etc.). The example comparative runtime analysis 600 includes the TensorRT platform runtimes 608 corresponding to a TensorRT platform. A TensorRT platform is a neural network inference optimizer and runtime engine for production deployment. In the illustrated example of FIG. 6, the RASR framework has a runtime of 27.7 milliseconds on the second processing platform.

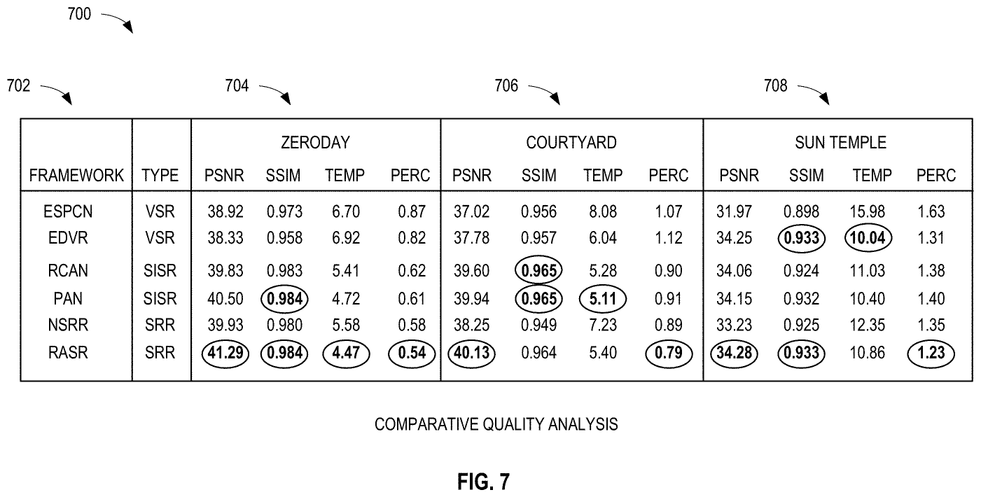

FIG. 7 shows results of a comparative quality analysis 700 of FIGS. 2 and/or 3 of example frameworks 702. The frameworks 702 include example super-resolution frameworks. For example, the frameworks 702 include VSR frameworks (e.g., ESPCN, EDVR), SISR frameworks (e.g., RCAN, PAN), SRR frameworks (e.g., NSRR), and the example techniques disclosed herein (e.g., RASR). The example comparative quality analysis 700 includes an example first dataset 704, an example second dataset 706, and an example third dataset 708. In some examples, the datasets 704, 706, 708 correspond to game engines. For example, the first dataset 704 corresponds to the game engine ZeroDay, the second dataset 706 corresponds to the game engine Courtyard, and the third dataset 708 corresponds to the game engine Sun Temple. For each of the datasets 704, 706, 708, the comparative quality analysis 700 includes four quality metrics: peak signal-to-noise ratio (PSNR), structural similarity index (SSIM), temporal L1 loss (TEMP), and perceptual loss using VGG19 network (PERC). For example, the four quality metrics measure image quality.

In the example table 700 of FIG. 7, the datasets 704, 706, 708 show quality metric scores for the four quality metrics as measured for the multiple frameworks 702. In the illustrated example, the relatively best quality metric scores are shown circled.

The example RASR framework for the first dataset 704 generates the best image quality. That is, the RASR framework has the highest PSNR, the highest SSIM (tied with the PAN framework), the lowest temporal loss, and the lowest perceptual loss. Referencing the comparative runtime analysis 600 of FIG. 6, the ESPCN framework had a shorter runtime compared to the RASR framework. However, the image quality of the ESPCN framework based on the four quality metrics is lower compared to the RASR framework for the datasets 704, 706, 708. The EDVR and RCAN frameworks have a greater number of parameters compared to the RASR framework (e.g., based on FIG. 6). However, the EDVR and RCAN frameworks have a lower image quality compared to the RASR framework. The NSRR framework utilizes a feature re-weighting module to handle the artifacts generated by the GPU motion vector. However, the feature re-weighting module in addition to the fixed learning rate of the NSRR framework do not handle relatively large camera motion. Thus, the NSRR framework generates images with a lower image quality.

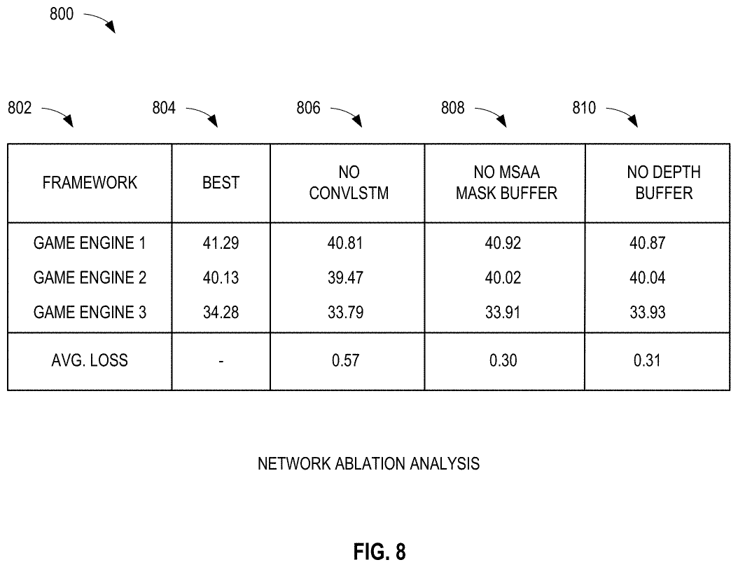

FIG. 8 shows results of a network ablation analysis 800 of FIGS. 2 and/or 3. The network ablation analysis 800 includes example datasets 802. For example, the datasets 802 correspond to game engines (e.g., ZeroDay, Courtyard, and Sun Temple). The example network ablation analysis 800 includes the PSNR metric for the datasets 802. The network ablation analysis 800 includes example benchmarks 804. The example benchmarks 804 correspond to the PSNR values of the datasets 802 of the rendered images generated by techniques disclosed herein (e.g., the RASR framework).

The network ablation analysis 800 includes an example first architecture 806, an example second architecture 808, and an example third architecture 810. The example first architecture 806 corresponds to the RASR framework without the ConvLSTM cells. That is, the example first architecture 806 does not include the network controller 206 of FIGS. 2 and/or 3. In the illustrated example of FIG. 8, the network controller 206 is removed, the input frame set 214 (FIG. 2) and/or the input frame set 302 (FIG. 3) include four aligned previous frames, and a feature re-weighting module is added. The PSNR of the datasets 802 of the first architecture 806 were lower than the PSNR of the benchmark 804 (e.g., an average loss of 0.57). Thus, aligning previous frames based on GPU motion vectors (e.g., the NSRR framework) introduces a large amount of noise into the high-resolution images.

The example second architecture 808 corresponds to the RASR framework without the MCS buffer. That is, the input frame set 214 and/or the input frame set 302 of the second architecture 808 do not include the MCS frame 222 and/or the MCS frame 308. In examples disclosed herein, the MCS frame indicates regions of interest for anti-aliasing. Thus, the MCs frame plays an important role in producing images with smooth outlines. The PSNR of the example datasets 802 of the second architecture 808 were lower than the PSNR of the example benchmark 804 (e.g., an average loss of 0.30). The example third architecture 810 corresponds to the RASR framework without the depth frame. That is, the example input frame set 214 does not include the depth frame 218 (FIG. 2). The PSNR of the example datasets 802 of the third architecture 810 were lower than the PSNR of the benchmark (e.g., an average loss of 0.31).

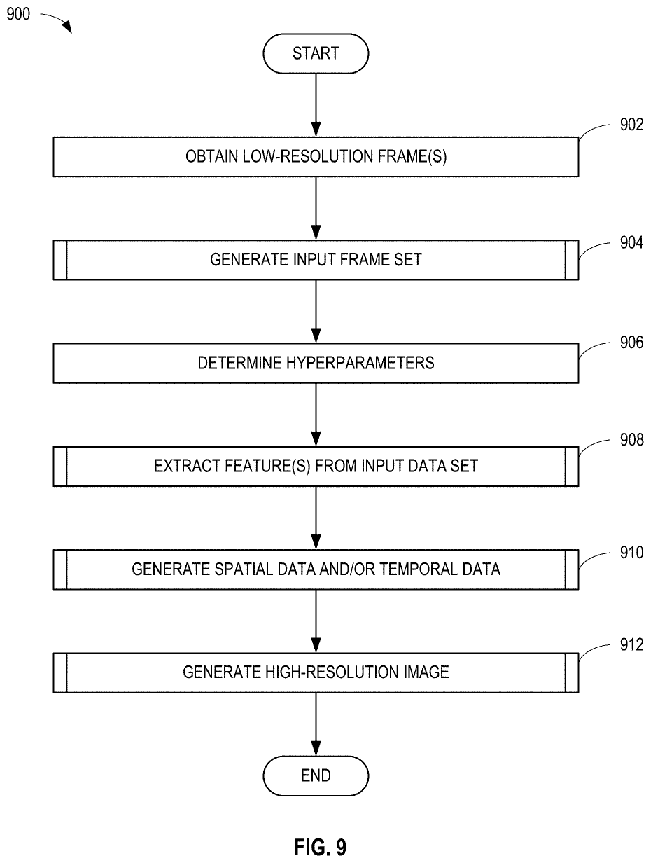

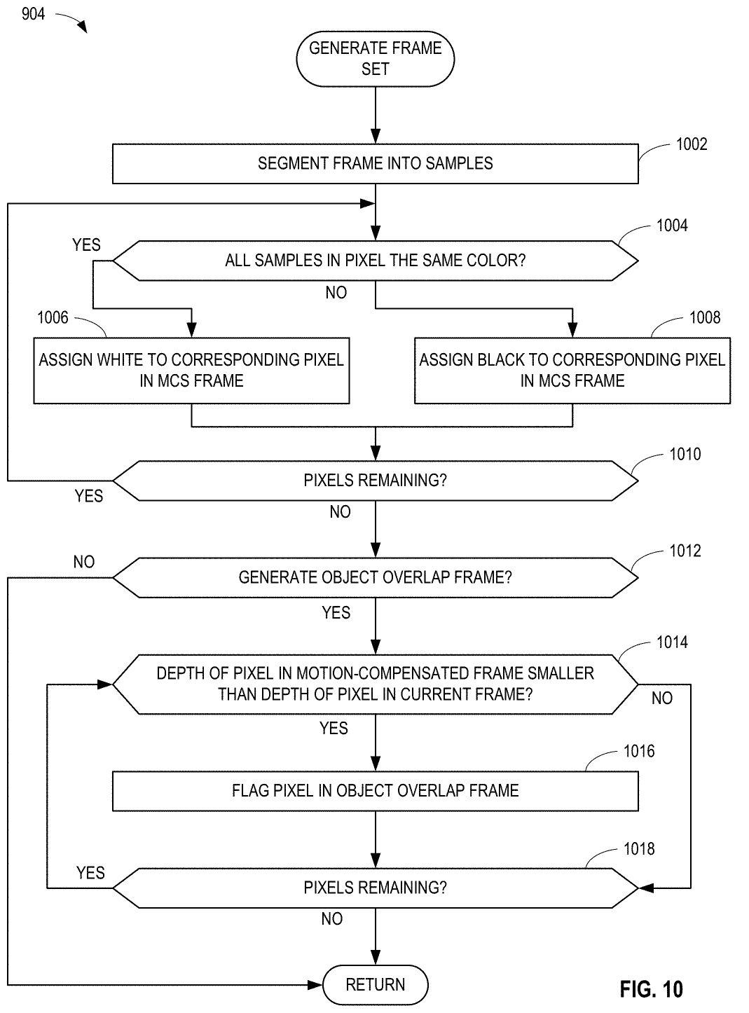

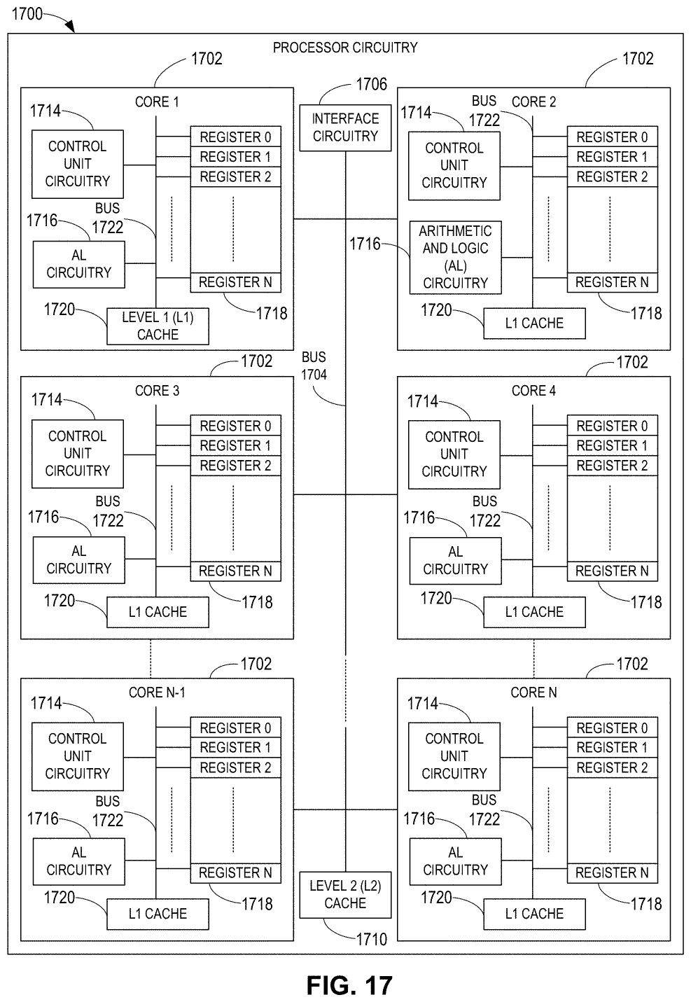

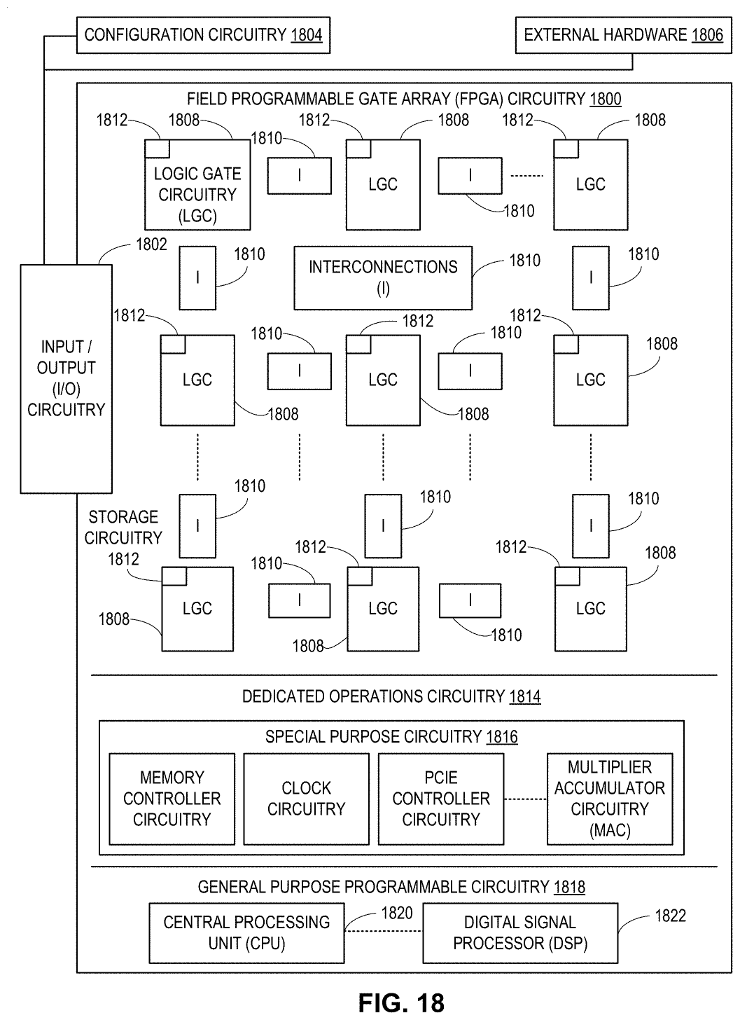

In some examples, the example super-resolution controller 104 includes means for generating a MCS frame. For example, the means for generating a MCS frame may be implemented by data handling circuitry (e.g., the example data handler 202). In some examples, the data handling circuitry may be implemented by machine executable instructions such as that implemented by at least blocks 902, 904 of FIG. 9, 1002, 1004, 1006, 1008, 1010, 1012, 1014, 1016, 1018 of FIG. 10 executed by processor circuitry, which may be implemented by the example processor circuitry 1412 of FIG. 14, the example processor circuitry 1700 of FIG. 17, and/or the example Field Programmable Gate Array (FPGA) circuitry 1800 of FIG. 18. In other examples, the data handling circuitry is implemented by other hardware logic circuitry, hardware implemented state machines, and/or any other combination of hardware, software, and/or firmware. For example, the data handling circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

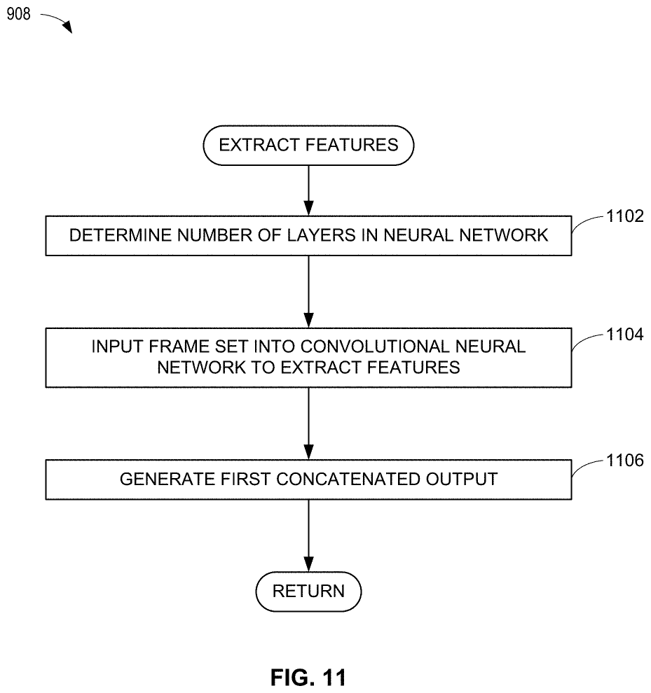

In some examples, the example super-resolution controller 104 includes means for obtaining features. For example, the means for obtaining features may be implemented by feature extracting circuitry (e.g., the example feature extractor 204). In some examples, the feature extracting circuitry may be implemented by machine executable instructions such as that implemented by at least blocks 908 of FIG. 9, 1102, 1104, 1106 of FIG. 11 executed by processor circuitry, which may be implemented by the example processor circuitry 1412 of FIG. 14, the example processor circuitry 1700 of FIG. 17, and/or the example Field Programmable Gate Array (FPGA) circuitry 1800 of FIG. 18. In other examples, the feature extracting circuitry is implemented by other hardware logic circuitry, hardware implemented state machines, and/or any other combination of hardware, software, and/or firmware. For example, the feature extracting circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

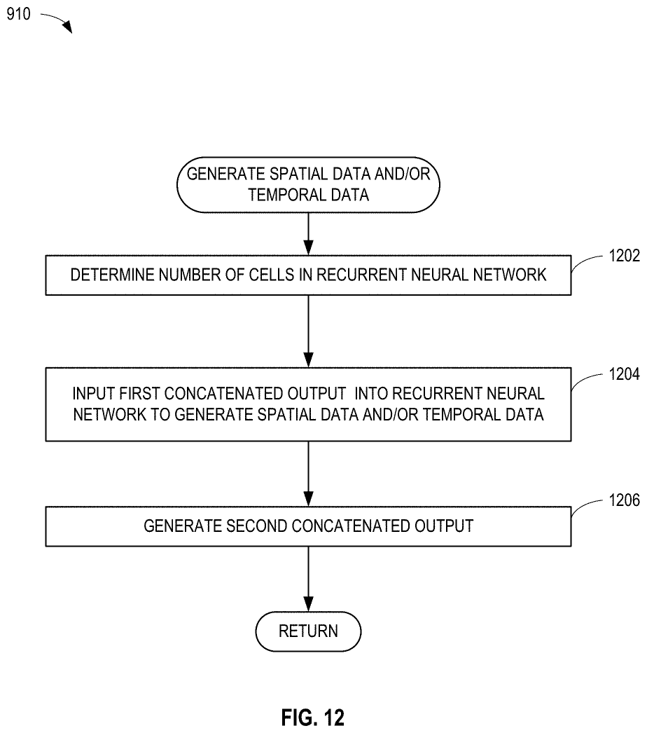

In some examples, the example super-resolution controller 104 includes means for generating spatial data and temporal data. For example, the means for generating spatial data and temporal data may be implemented by network controlling circuitry (e.g., the network controller 206). In some examples, the network controlling circuitry may be implemented by machine executable instructions such as that implemented by at least blocks 910 of FIG. 9, 1202, 1204, 1206 of FIG. 12 executed by processor circuitry, which may be implemented by the example processor circuitry 1412 of FIG. 14, the example processor circuitry 1700 of FIG. 17, and/or the example Field Programmable Gate Array (FPGA) circuitry 1800 of FIG. 18. In other examples, the network controlling circuitry is implemented by other hardware logic circuitry, hardware implemented state machines, and/or any other combination of hardware, software, and/or firmware. For example, the network controlling circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

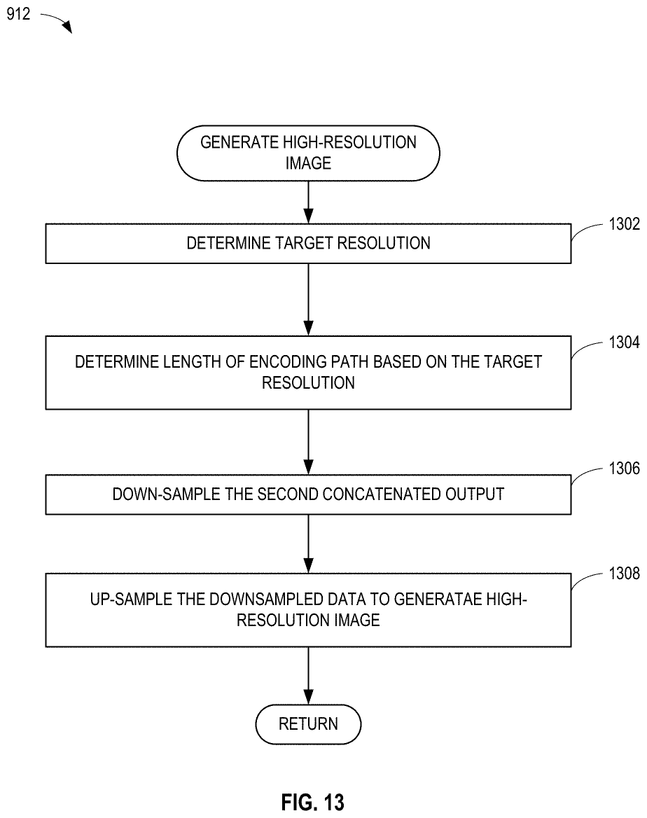

In some examples, the example super-resolution controller 104 includes means for generating a high-resolution image. For example, the means for generating a high-resolution image may be implemented by reconstructing circuitry (e.g., the reconstructor 208). In some examples, the reconstructing circuitry may be implemented by machine executable instructions such as that implemented by at least blocks 912 of FIG. 9, 1302, 1304, 1306, 1308 of FIG. 13 executed by processor circuitry, which may be implemented by the example processor circuitry 1412 of FIG. 14, the example processor circuitry 1700 of FIG. 17, and/or the example Field Programmable Gate Array (FPGA) circuitry 1800 of FIG. 18. In other examples, the reconstructing circuitry is implemented by other hardware logic circuitry, hardware implemented state machines, and/or any other combination of hardware, software, and/or firmware. For example, the reconstructing circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the example super-resolution controller 104 includes means for configuring network design parameters. For example, the means for configuring network design parameters may be implemented by autotuning circuitry (e.g., the autotuner 212). In some examples, the autotuning circuitry may be implemented by machine executable instructions such as that implemented by at least block 906 of FIG. 9 executed by processor circuitry, which may be implemented by the example processor circuitry 1412 of FIG. 14, the example processor circuitry 1700 of FIG. 17, and/or the example Field Programmable Gate Array (FPGA) circuitry 1800 of FIG. 18. In other examples, the autotuning circuitry is implemented by other hardware logic circuitry, hardware implemented state machines, and/or any other combination of hardware, software, and/or firmware. For example, the autotuning circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the super-resolution controller 104 of FIGS. 1A-1B is illustrated in FIGS. 2-3, one or more of the elements, processes and/or devices illustrated in FIGS. 2-3 may be combined, divided, re-arranged, omitted, eliminated, and/or implemented in any other way. Further, the example data handler 202, the example feature extractor 204, the example network controller 206, the example reconstructor 208, the example model trainer 210, the example autotuner 212, and/or, more generally, the example super-resolution controller 104 of FIGS. 2-3, may be implemented by hardware, software, firmware and/or any combination of hardware, software, and/or firmware. Thus, for example, any of the example data handler 202, the example feature extractor 204, the example network controller 206, the example reconstructor 208, the example model trainer 210, the example autotuner 212, and/or, more generally, the example super-resolution controller 104, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example, data handler 202, the example feature extractor 204, the example network controller 206, the example reconstructor 208, the example model trainer 210, the example autotuner 212 and/or the example super-resolution controller 104 is/are hereby expressly defined to include a non-transitory computer readable storage device or storage disk such as a memory, a digital versatile disk (DVD), a compact disk (CD), a Blu-ray disk, etc., including the software and/or firmware. Further still, the example super-resolution controller 104 of FIG. 1 may include one or more elements, processes, and/or devices in addition to, or instead of, those illustrated in FIGS. 2-3, and/or may include more than one of any or all of the illustrated elements, processes and devices.

Flowchart representative of example hardware logic circuitry, machine readable instructions, hardware implemented state machines, and/or any combination thereof for implementing the super-resolution controller 104 of FIGS. 1, 2, and/or 3 are shown in FIGS. 9-13. The machine readable instructions may be one or more executable programs or portion(s) of an executable program for execution by processor circuitry, such as the processor circuitry 1412 shown in the example processor platform 1400 discussed below in connection with FIG. 4 and/or the example processor circuitry discussed below in connection with FIGS. 5 and/or 6. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 9-13, many other methods of implementing the example super-resolution controller 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9-13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions that may be executed to implement the example super-resolution controller 104 of FIGS. 1A, 1B, 2, and 3 for super-resolution rendering. The example program 900 of FIG. 9 begins at block 902 at which the data handler 202 (FIG. 2) obtains one or more low-resolution frames. For example, the data handler 202 obtains the low-resolution frames generated by the renderer 102 (FIG. 1). In some examples, the low-resolution frames include color frames and/or depth frames.

At block 904, the example data handler 202 generates an input frame set. For example, the data handler 202 generates an MCS frame. In some examples, the data handler 202 generates an object overlap frame. Example instructions that may be used to implement block 904 to generate an input frame set are described in more detail below in connection with FIG. 10.

At block 906, the example autotuner 212 (FIG. 2) determines hyperparameters. For example, the autotuner 212 determines the hyperparameters of the super-resolution controller 104 based on network settings. The example autotuner 212 determines the hyperparameters (e.g., learning rate, weight decay, etc.) based on Table 1 above.

At block 908, the example feature extractor 204 (FIG. 2) extracts one or more features from the input data set. For example, the feature extractor 204 inputs the input data set into a convolutional neural network to generate learnable features. Example instructions that may be used to implement block 908 to extract features are described in more detail below in connection with FIG. 11.

At block 910, the example network controller 206 (FIG. 2) generates spatial data and/or temporal data. For example, the network controller 206 obtains and inputs the input frame set and/or the features into a recurrent neural network. Example instructions that may be used to implement block 910 to generate spatial data and/or temporal data are described in more detail below in connection with FIG. 12.

At block 912, the example reconstructor 208 (FIG. 2) generates a high-resolution image. For example, the reconstructor 208 obtains and down-samples the input frame set, the features, the spatial data, and/or the temporal data. The example reconstructor 208 up-samples the frame set to a target resolution to generate the high-resolution image (e.g., the high-resolution image 224 of FIG. 2 and/or the high-resolution image 324 of FIG. 3). Example instructions that may be used to implement block 912 to generate the high-resolution image are described in more detail below in connection with FIG. 13.

FIG. 10 is a flowchart representative of example machine readable instructions that may be executed to implement the example data handler 202 of FIG. 2 to generate frame sets. The example instructions represented in FIG. 10 may be used to implement block 904 of FIG. 9. At blocks 1002-1010, the example data handler 202 generates an MCS frame (e.g., the MCS frame 222 of FIG. 2 and/or the MCS frame 308 of FIG. 3). The example program of FIG. 10 begins at block 1002 at which the data handler 202 segments the frame into samples. For example, the data handler 202 determines the number of samples to rasterize for each pixel (e.g., 1 ×, 2×, 4×, 8×, 16×, etc.) of a frame and segments the frame into that number of samples. For example, the data handler 202 determines the color of the MCS pixel based on the samples of the pixel.

At block 1004, the example data handler 202 determines whether all of the samples in a pixel are the same color. If, at block 1004, the example data handler 202 determines all of the samples in the pixel are the same color, the program 904 continues to block 1006, where the data handler 202 assigns the color white to the corresponding pixel of the MCS frame. If, at block 1004, the example data handler 202 determines all of the samples in the pixel are not the same color, the program 904 continues to block 1008, where the data handler 202 assigns the color black to the corresponding pixel of the MCS frame.

At block 1010, the example data handler 202 determines whether there are pixels remaining. For example, the data handler 202 determines whether there are pixels of the color frame that have not been segmented and/or analyzed. If, at block 1010, the example data handler 202 determines there are pixels remaining, the program 904 returns to block 1004. If, at block 1010, the example data handler 202 determines there are no pixels remaining, the program 904 continues to block 1012.

At blocks 1012-1018, the example data handler 202 generates an object overlap frame (e.g., the object overlap frame 220 of FIG. 2 and/or the object overlap frame 310 of FIG. 3). At block 1012, the example data handler 202 determines whether to generate the object overlap frame. For example, the data handler 202 determines whether the input frame set includes a current frame and a previous frame. In some examples, if the data handler 202 determines the input frame set does not include the previous frame, the data handler 202 determines to not generate the object overlap frame. If, at block 1012, the example data handler 202 determines to not generate the object overlap frame, the program 904 returns to block 906 of FIG. 9. If, at block 1012, the example data handler 202 determines to generate the object overlap frame, the program 904 continues to block 1014.

At block 1014, the example data handler 202 determines whether the depth of a pixel in a motion compensated frame is smaller than the depth of the corresponding pixel in the current frame. If, at block 1014, the example data handler 202 determines the depth of the pixel in the motion compensated frame is not smaller than the depth of the pixel in the current frame, the program 904 continues to block 1018. If, at block 1014, the example data handler 202 determines the depth of the pixel in the motion compensated frame is smaller than the depth of the pixel in the current frame, the program continues to block 1016, where the data handler 202 flags the pixel in the object overlap frame.

At block 1018, the example data handler 202 determines whether there are pixels remaining. For example, the data handler 202 determines whether there are pixels of the depth frame that have not been analyzed. If, at block 1018, the example data handler 202 determines there are pixels remaining, the program 904 returns to block 1014. If, at block 1018, the example data handler 202 determines there are no pixels remaining, the example program 904 returns to block 906 of FIG. 9.

FIG. 11 is a flowchart representative of example machine readable instructions that may be executed to implement the example feature extractor 204 of FIGS. 2 and/or 3 to extract features. The example instructions represented in FIG. 11 may be used to implement block 908 of FIG. 9. The example program of FIG. 11 begins at block 1102 at which the feature extractor 204 determines the number of layers in the neural network. For example, the feature extractor 204 determines the number of layers in the convolutional neural network based on the hyperparameters determined by the autotuner 212 (e.g., the hyperparameters determined at block 906 of FIG. 9).

At block 1104, the example feature extractor 204 inputs the input frame set into the convolutional neural network to extract features. For example, the feature extractor 204 extracts learnable features. At block 1106, the example feature extractor 204 generates a first concatenated output. For example, the feature extractor 204 concatenates the input frame set and the features. The example program 908 returns to block 910 of FIG. 9.

FIG. 12 is a flowchart representative of example machine readable instructions that may be executed to implement the example network controller 206 of FIGS. 2 and/or 3 to generate spatial data and/or temporal data. The example instructions represented in FIG. 12 may be used to implement block 910 of FIG. 9. The example program of FIG. 12 begins at block 1202 at which the network controller 206 determines a number of cells in the recurrent neural network. For example, the network controller 206 determines the number of ConvLSTM cells based on the hyperparameters determined by the autotuner 212 (e.g., the hyperparameters determined at block 906 of FIG. 9).

At block 1204, the example network controller 206 inputs the first concatenated output into the recurrent neural network to generate spatial data and/or temporal data. For example, if the output of the ConvLSTM cells models the motion between successive frames. At block 1206, the example network controller 206 generates a second concatenated output. For example, the network controller 206 concatenates the input frame set, the features, the spatial data, and/or the temporal data. The example program 910 returns to block 912 of FIG. 9.

FIG. 13 is a flowchart representative of example machine readable instructions that may be executed to implement the example reconstructor 208 of FIGS. 2 and/or 3 to generate a high-resolution image. The example instructions represented in FIG. 13 may be used to implement block 912 of FIG. 9. The example program of FIG. 13 begins at block 1302 at which the reconstructor 208 determines a target resolution. For example, the reconstructor 208 determines the target resolution of the high-resolution image.

At block 1304, the example reconstructor 208 determines the length of the encoding path based on the target resolution. For example, the reconstructor 208 reduces the length of the down-sampling path based on the target resolution. At block 1306, the example reconstructor 208 down-samples the second concatenated output. At block 1308, the example reconstructor 208 up-samples the down-sampled data to generate the high-resolution image. That is, the example reconstructor 208 generates an image with the target resolution (e.g., determined at block 1302). The example program 912 returns to FIG. 9.

FIG. 14 is a block diagram of an example processor platform 1400 structured to execute and/or instantiate the machine readable instructions and/or operations of FIGS. 9-13 to implement the super-resolution controller 104 of FIGS. 1A, 1B, 2, 3, and/or 4. The processor platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs microprocessors, CPUs, GPUs, DSPs, and/or microcontrollers from any desired family or manufacturer. The processor circuitry 1412 may be implemented by one or more semiconductor based (e.g., silicon based) devices. In the illustrated example of FIG. 14, the processor platform 1400 includes a GPU 1434. In this example, the processor implements the example data handler 202, the example feature extractor 204, the example network controller 206, the example reconstructor 208, the example model trainer 210, and the example autotuner 212.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1432, which may be implemented by the machine readable instructions of FIGS. 9-13, may be stored in the mass storage device 1428, in the volatile memory 1414, in the non-volatile memory 1416, and/or on a removable non-transitory computer readable storage medium such as a CD or DVD.

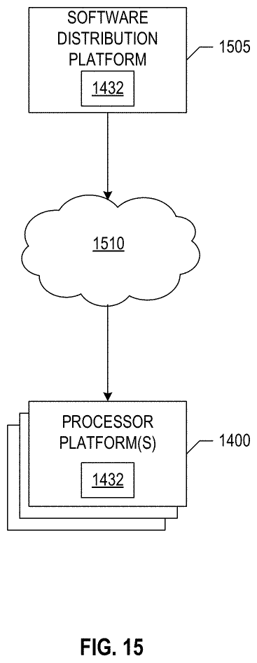

A block diagram illustrating an example software distribution platform 1505 to distribute software such as the example machine readable instructions 1432 of FIG. 14 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1432, which may correspond to the example machine readable instructions of FIGS. 9-13, as described above. The one or more servers of the example software distribution platform 1505 are in communication with a network 1510, which may correspond to any one or more of the Internet and/or any of the example network 1426 described above. In some examples, the one or more servers are responsive to requests to transmit the software to a requesting party as part of a commercial transaction. Payment for the delivery, sale and/or license of the software may be handled by the one or more servers of the software distribution platform and/or by a third party payment entity. The servers enable purchasers and/or licensors to download the machine readable instructions 1432 from the software distribution platform 1505. For example, the software, which may correspond to the example machine readable instructions of FIGS. 9-13, may be downloaded to the example processor platform 1400, which is to execute the machine readable instructions 1432 to implement the super-resolution controller 104. In some example, one or more servers of the software distribution platform 1505 periodically offer, transmit, and/or force updates to the software (e.g., the example machine readable instructions 1432 of FIG. 14) to ensure improvements, patches, updates, etc. are distributed and applied to the software at the end user devices.

FIG. 16 illustrates an example color frame 1600 and an example MCS frame 1602. For example, the frames 1600, 1602 are part of the input frame sets (e.g., the input frame set 214 of FIG. 2, the input frame set 302 of FIG. 3, etc.). That is, the example color frame 1600 corresponds to the color frame 216 (FIG. 2) and/or the color frames 304, 306 (FIG. 3). The example MCS frame 1602 corresponds to the MCS frame 222 (FIG. 2) and/or the MCS frame 308 (FIG. 3).

In some examples, the data handler 202 (FIG. 2) generates the MCS frame 1602 based on the color frame 1600. For example, the data handler 202 segments the pixels of an example first region 1604 of the color frame 1600 into samples. The example data handler 202 determines the samples of the pixels of the region 1604 are all the same color and, thus, determines the corresponding pixels of an example first region 1606 of the MCS frame 1602 are white. Additionally or alternatively, the example data handler 202 segments the pixels of an example second region 1608 of the color frame 1600 into samples. In the illustrated example of FIG. 16, the second region 1608 includes an example object 1610. The example data handler 202 determines the samples of the pixels corresponding to the outline of the object 1610 are not all the same color. Therefore, the example data handler 202 determines the corresponding pixels of the outline of the object 1610 are black (e.g., in an example second region 1612 of the MCS frame 1602).

FIG. 17 is a block diagram of an example implementation of the processor circuitry 1412 of FIG. 14. In this example, the processor circuitry 1412 of FIG. 14 is implemented by a microprocessor 1700. For example, the microprocessor 1700 may implement multi-core hardware circuitry such as a CPU, a DSP, a GPU, an XPU, etc. Although it may include any number of example cores 1702 (e.g., 1 core), the microprocessor 1700 of this example is a multi-core semiconductor device including N cores. The cores 1702 of the microprocessor 1700 may operate independently or may cooperate to execute machine readable instructions. For example, machine code corresponding to a firmware program, an embedded software program, or a software program may be executed by one of the cores 1702 or may be executed by multiple ones of the cores 1702 at the same or different times. In some examples, the machine code corresponding to the firmware program, the embedded software program, or the software program is split into threads and executed in parallel by two or more of the cores 1702. The software program may correspond to a portion or all of the machine readable instructions and/or operations represented by the flowcharts of FIGS. 9-13.

The cores 1702 may communicate by an example bus 1704. In some examples, the bus 1704 may implement a communication bus to effectuate communication associated with one(s) of the cores 1702. For example, the bus 1704 may implement at least one of an Inter-Integrated Circuit (I2C) bus, a Serial Peripheral Interface (SPI) bus, a PCI bus, or a PCIe bus. Additionally or alternatively, the bus 1704 may implement any other type of computing or electrical bus. The cores 1702 may obtain data, instructions, and/or signals from one or more external devices by example interface circuitry 1706. The cores 1702 may output data, instructions, and/or signals to the one or more external devices by the interface circuitry 1706. Although the cores 1702 of this example include example local memory 1720 (e.g., Level 1 (L1) cache that may be split into an L1 data cache and an L1 instruction cache), the microprocessor 1700 also includes example shared memory 1710 that may be shared by the cores (e.g., Level 2 (L2_cache)) for high-speed access to data and/or instructions. Data and/or instructions may be transferred (e.g., shared) by writing to and/or reading from the shared memory 1710. The local memory 1720 of each of the cores 1702 and the shared memory 1710 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1702 may be referred to as a CPU, DSP, GPU, etc., or any other type of hardware circuitry. Each core 1702 includes control unit circuitry 1714, arithmetic and logic (AL) circuitry (sometimes referred to as an ALU) 1716, a plurality of registers 1718, the L1 cache 1720, and an example bus 1722. Other structures may be present. For example, each core 1702 may include vector unit circuitry, single instruction multiple data (SIMD) unit circuitry, load/store unit (LSU) circuitry, branch/jump unit circuitry, floating-point unit (FPU) circuitry, etc. The control unit circuitry 1714 includes semiconductor-based circuits structured to control (e.g., coordinate) data movement within the corresponding core 1702. The AL circuitry 1716 includes semiconductor-based circuits structured to perform one or more mathematic and/or logic operations on the data within the corresponding core 1702. The AL circuitry 1716 of some examples performs integer based operations. In other examples, the AL circuitry 1716 also performs floating point operations. In yet other examples, the AL circuitry 1716 may include first AL circuitry that performs integer based operations and second AL circuitry that performs floating point operations. In some examples, the AL circuitry 1716 may be referred to as an Arithmetic Logic Unit (ALU). The registers 1718 are semiconductor-based structures to store data and/or instructions such as results of one or more of the operations performed by the AL circuitry 1716 of the corresponding core 1702. For example, the registers 1718 may include vector register(s), SIMD register(s), general purpose register(s), flag register(s), segment register(s), machine specific register(s), instruction pointer register(s), control register(s), debug register(s), memory management register(s), machine check register(s), etc. The registers 1718 may be arranged in a bank as shown in FIG. 17. Alternatively, the registers 1718 may be organized in any other arrangement, format, or structure including distributed throughout the core 1702 to shorten access time. The bus 1722 may implement at least one of an I2C bus, a SPI bus, a PCI bus, or a PCIe bus

Each core 1702 and/or, more generally, the microprocessor 1700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 18 is a block diagram of another example implementation of the processor circuitry 1412 of FIG. 14. In this example, the processor circuitry 1412 is implemented by FPGA circuitry 1800. The FPGA circuitry 1800 can be used, for example, to perform operations that could otherwise be performed by the example microprocessor 1700 of FIG. 17 executing corresponding machine readable instructions. However, once configured, the FPGA circuitry 1800 instantiates the machine readable instructions in hardware and, thus, can often execute the operations faster than they could be performed by a general purpose microprocessor executing the corresponding software.

More specifically, in contrast to the microprocessor 1700 of FIG. 17 described above (which is a general purpose device that may be programmed to execute some or all of the machine readable instructions represented by the flowchart of FIGS. 9-13 but whose interconnections and logic circuitry are fixed once fabricated), the FPGA circuitry 1800 of the example of FIG. 18 includes interconnections and logic circuitry that may be configured and/or interconnected in different ways after fabrication to instantiate, for example, some or all of the machine readable instructions represented by the flowcharts of FIGS. 9-13. In particular, the FPGA 1800 may be thought of as an array of logic gates, interconnections, and switches. The switches can be programmed to change how the logic gates are interconnected by the interconnections, effectively forming one or more dedicated logic circuits (unless and until the FPGA circuitry 1800 is reprogrammed). The configured logic circuits enable the logic gates to cooperate in different ways to perform different operations on data received by input circuitry. Those operations may correspond to some or all of the software represented by the flowcharts of FIGS. 9-13. As such, the FPGA circuitry 1800 may be structured to effectively instantiate some or all of the machine readable instructions of the flowcharts of FIGS. 9-13 as dedicated logic circuits to perform the operations corresponding to those software instructions in a dedicated manner analogous to an ASIC. Therefore, the FPGA circuitry 1800 may perform the operations corresponding to the some or all of the machine readable instructions of FIGS. 9-13 faster than the general purpose microprocessor can execute the same.

In the example of FIG. 18, the FPGA circuitry 1800 is structured to be programmed (and/or reprogrammed one or more times) by an end user by a hardware description language (HDL) such as Verilog. The FPGA circuitry 1800 of FIG. 18, includes example input/output (I/O) circuitry 1802 to obtain and/or output data to/from example configuration circuitry 1804 and/or external hardware (e.g., external hardware circuitry) 1806. For example, the configuration circuitry 1804 may implement interface circuitry that may obtain machine readable instructions to configure the FPGA circuitry 1800, or portion(s) thereof. In some such examples, the configuration circuitry 1804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1806 may implement the microprocessor 1700 of FIG. 17. The FPGA circuitry 1800 also includes an array of example logic gate circuitry 1808, a plurality of example configurable interconnections 1810, and example storage circuitry 1812. The logic gate circuitry 1808 and interconnections 1810 are configurable to instantiate one or more operations that may correspond to at least some of the machine readable instructions of FIGS. 9-13 and/or other desired operations. The logic gate circuitry 1808 shown in FIG. 18 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1808 to enable configuration of the electrical structures and/or the logic gates to form circuits to perform desired operations. The logic gate circuitry 1808 may include other electrical structures such as look-up tables (LUTs), registers (e.g., flip-flops or latches), multiplexers, etc.

The interconnections 1810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1808 to program desired logic circuits.

The storage circuitry 1812 of the illustrated example is structured to store result(s) of the one or more of the operations performed by corresponding logic gates. The storage circuitry 1812 may be implemented by registers or the like. In the illustrated example, the storage circuitry 1812 is distributed amongst the logic gate circuitry 1808 to facilitate access and increase execution speed.

The example FPGA circuitry 1800 of FIG. 18 also includes example Dedicated Operations Circuitry 1814. In this example, the Dedicated Operations Circuitry 1814 includes special purpose circuitry 1816 that may be invoked to implement commonly used functions to avoid the need to program those functions in the field. Examples of such special purpose circuitry 1816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1800 may also include example general purpose programmable circuitry 1818 such as an example CPU 1820 and/or an example DSP 1822. Other general purpose programmable circuitry 1818 may additionally or alternatively be present such as a GPU, an XPU, etc., that can be programmed to perform other operations.

Although FIGS. 17 and 18 illustrate two example implementations of the processor circuitry 1412 of FIG. 14, many other approaches are contemplated. For example, as mentioned above, modern FPGA circuitry may include an on-board CPU, such as one or more of the example CPU 1820 of FIG. 18. Therefore, the processor circuitry 1412 of FIG. 14 may additionally be implemented by combining the example microprocessor 1700 of FIG. 17 and the example FPGA circuitry 1800 of FIG. 18. In some such hybrid examples, a first portion of the machine readable instructions represented by the flowcharts of FIGS. 9-13 may be executed by one or more of the cores 1702 of FIG. 17 and a second portion of the machine readable instructions represented by the flowcharts of FIGS. 9-13may be executed by the FPGA circuitry 1800 of FIG. 18.

In some examples, the processor circuitry 1412 of FIG. 14 may be in one or more packages. For example, the processor circuitry 1700 of FIG. 17 and/or the FPGA circuitry 1800 of FIG. 18 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

From the foregoing, it will be appreciated that example methods, apparatus and articles of manufacture have been disclosed for super-resolution rendering. The disclosed methods, apparatus and articles of manufacture improve the efficiency of using a computing device by rendering a frame at a lower resolution and up-sampling the low-resolution frame to a target resolution. The disclosed methods, apparatus and articles of manufacture reduce computing time and bandwidth requirements for real-time rendering. For example, the disclosed methods, apparatus, and articles of manufacture obtain one previous frame, thus reducing storage requirements and computing time. The disclosed methods, apparatus and articles of manufacture are accordingly directed to one or more improvement(s) in the functioning of a computer.

Example methods, apparatus, systems, and articles of manufacture for super-resolution rendering are disclosed herein. Further examples and combinations thereof include the following:

Example 1 includes an apparatus, comprising a data handler to generate a multi-sample control surface (MCS) frame based on a color frame, a feature extractor to obtain features from the color frame, a depth frame, and the MCS frame, a network controller to generate spatial data and temporal data based on the features, and a reconstructor to generate a high-resolution image based on the features, the spatial data, and the temporal data.

Example 2 includes the apparatus of example 1, wherein the depth frame is a first depth frame, and the data handler is to generate an object overlap frame based on a comparison between the first depth frame and a second depth frame, the second depth frame corresponding to a first time, the first time before a second time corresponding to the first depth frame.

Example 3 includes the apparatus of example 2, wherein the network controller is to determine the spatial data and the temporal data based on the object overlap frame.

Example 4 includes the apparatus of example 1, wherein the network controller is to determine the spatial data and the temporal data using a convolutional long short-term memory cell.

Example 5 includes the apparatus of example 1, wherein the reconstructor includes a convolutional neural network, the convolutional neural network including at least one encoder to generate encoded data by down-sampling the features, the spatial data, and the temporal data, and at least one decoder to up-sample the encoded data to generate the high-resolution image based on a network up-sampling scale.

Example 6 includes the apparatus of example 5, wherein the convolutional neural network is an unbalanced convolutional neural network, and the reconstructor is to reduce a length of an encoder path based on the network up-sampling scale.

Example 7 includes the apparatus of example 1, further including an autotuner to configure one or more network design parameters, the one or more network design parameters including at least one of a learning rate, a weight decay, a batch size, a number of convolutional layers, a number of convolutional long short-term memory cells, or a number of encoder stages.

Example 8 includes the apparatus of example 1, wherein the data handler is to determine a first pixel of the MCS frame is white in response to determining first samples of the first pixel corresponding to the color frame are the same color, and determine a second pixel of the MCS frame is black in response to determining second samples of the second pixel corresponding to the color frame are not the same color.

Example 9 includes an apparatus, comprising at least one memory, instructions, and at least one processor to execute the instructions to generate a multi-sample control surface (MCS) frame based on a color frame, obtain features from the color frame, a depth frame, and the MCS frame, generate spatial data and temporal data based on the features, and generate a high-resolution image based on the features, the spatial data, and the temporal data.

Example 10 includes the apparatus of example 9, wherein the depth frame is a first depth frame, and the at least one processor is to execute the instructions to generate an object overlap frame based on a comparison between the first depth frame and a second depth frame, the second depth frame corresponding to a first time, the first time before a second time corresponding to the first depth frame.

Example 11 includes the apparatus of example 10, wherein the at least one processor is to execute the instructions to determine the spatial data and the temporal data based on the object overlap frame.

Example 12 includes the apparatus of example 9, wherein the at least one processor is to execute the instructions to determine the spatial data and the temporal data using a convolutional long short-term memory cell.

Example 13 includes the apparatus of example 9, wherein the at least one processor is to execute the instructions to generate encoded data by down-sampling the features, the spatial data, and the temporal data, and up-sample the encoded data to generate the high-resolution image based on a network up-sampling scale.

Example 14 includes the apparatus of example 13, wherein the at least one processor is to execute the instructions to reduce a length of an encoder path based on the network up-sampling scale.

Example 15 includes the apparatus of example 9, wherein the at least one processor is to execute the instructions to configure one or more network design parameters, the one or more network design parameters including at least one of a learning rate, a weight decay, a batch size, a number of convolutional layers, a number of convolutional long short-term memory cells, or a number of encoder stages.

Example 16 includes the apparatus of example 9, wherein the at least one processor is to execute the instructions to determine a first pixel of the MCS frame is white in response to determining first samples of the first pixel corresponding to the color frame are the same color, and determine a second pixel of the MCS frame is black in response to determining second samples of the second pixel corresponding to the color frame are not the same color.

Example 17 includes at least one non-transitory computer readable medium comprising instructions that, when executed, cause at least one processor to at least generate a multi-sample control surface (MCS) frame based on a color frame, obtain features from the color frame, a depth frame, and the MCS frame, generate spatial data and temporal data based on the features, and generate a high-resolution image based on the features, the spatial data, and the temporal data.

Example 18 includes the at least one non-transitory computer readable medium of example 17, wherein the depth frame is a first depth frame, and the instructions, when executed, cause the at least one processor to generate an object overlap frame based on a comparison between the first depth frame and a second depth frame, the second depth frame corresponding to a first time, the first time before a second time corresponding to the first depth frame.

Example 19 includes the at least one non-transitory computer readable medium of example 18, wherein the instructions, when executed, cause the at least one processor to determine the spatial data and the temporal data based on the object overlap frame.

Example 20 includes the at least one non-transitory computer readable medium of example 17, wherein the instructions, when executed, cause the at least one processor to determine the spatial data and the temporal data using a convolutional long short-term memory cell.

Example 21 includes the at least one non-transitory computer readable medium of example 17, wherein the instructions, when executed, cause the at least one processor to generate encoded data by down-sampling the features, the spatial data, and the temporal data, and up-sample the encoded data to generate the high-resolution image based on a network up-sampling scale.

Example 22 includes the at least one non-transitory computer readable medium of example 21, wherein the instructions, when executed, cause the at least one processor to reduce a length of an encoder path based on the network up-sampling scale.

Example 23 includes the at least one non-transitory computer readable medium of example 17, wherein the instructions, when executed, cause the at least one processor to configure one or more network design parameters, the one or more network design parameters including at least one of a learning rate, a weight decay, a batch size, a number of convolutional layers, a number of convolutional long short-term memory cells, or a number of encoder stages.

Example 24 includes the at least one non-transitory computer readable medium of example 17, wherein the instructions, when executed, cause the at least one processor to determine a first pixel of the MCS frame is white in response to determining first samples of the first pixel corresponding to the color frame are the same color, and determine a second pixel of the MCS frame is black in response to determining second samples of the second pixel corresponding to the color frame are not the same color.

Example 25 includes a method, comprising generating, by executing an instruction with a processor, a multi-sample control surface (MCS) frame based on a color frame, obtaining, by executing an instruction with the processor, features from the color frame, a depth frame, and the MCS frame, generating, by executing an instruction with the processor, spatial data and temporal data based on the features, and generating, by executing an instruction with the processor, a high-resolution image based on the features, the spatial data, and the temporal data.

Example 26 includes the method of example 25, wherein the depth frame is a first depth frame, and further including generating an object overlap frame based on a comparison between the first depth frame and a second depth frame, the second depth frame corresponding to a first time, the first time before a second time corresponding to the first depth frame.

Example 27 includes the method of example 26, further including determining the spatial data and the temporal data based on the object overlap frame.

Example 28 includes the method of example 25, further including determining the spatial data and the temporal data using a convolutional long short-term memory cell.

Example 29 includes the method of example 25, further including generating encoded data by down-sampling the features, the spatial data, and the temporal data, and up-sampling the encoded data to generate the high-resolution image based on a network up-sampling scale.

Example 30 includes the method of example 29, further including reducing a length of an encoder path based on the network up-sampling scale.

Example 31 includes the method of example 25, further including configuring one or more network design parameters, the one or more network design parameters including at least one of a learning rate, a weight decay, a batch size, a number of convolutional layers, a number of convolutional long short-term memory cells, or a number of encoder stages.

Example 32 includes the method of example 25, further including determining a first pixel of the MCS frame is white in response to determining first samples of the first pixel corresponding to the color frame are the same color, and determining a second pixel of the MCS frame is black in response to determining second samples of the second pixel corresponding to the color frame are not the same color.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus, comprising:
a data handler to generate a multi-sample control surface (MCS) frame based on a color frame;
a feature extractor to obtain features from the color frame, a depth frame, and the MCS frame;
a network controller to generate spatial data and temporal data based on the features; and
a reconstructor to generate a high-resolution image based on the features, the spatial data, and the temporal data.

2. The apparatus of claim 1, wherein the depth frame is a first depth frame, and the data handler is to generate an object overlap frame based on a comparison between the first depth frame and a second depth frame, the second depth frame corresponding to a first time, the first time before a second time corresponding to the first depth frame.

3. The apparatus of claim 2, wherein the network controller is to determine the spatial data and the temporal data based on the object overlap frame.

4. The apparatus of claim 1, wherein the network controller is to determine the spatial data and the temporal data using a convolutional long short-term memory cell.

5. The apparatus of claim 1, wherein the reconstructor includes a convolutional neural network, the convolutional neural network including:
at least one encoder to generate encoded data by down-sampling the features, the spatial data, and the temporal data; and
at least one decoder to up-sample the encoded data to generate the high-resolution image based on a network up-sampling scale.

6. The apparatus of claim 5, wherein the convolutional neural network is an unbalanced convolutional neural network, and the reconstructor is to reduce a length of an encoder path based on the network up-sampling scale.

7. The apparatus of claim 1, further including an autotuner to configure one or more network design parameters, the one or more network design parameters including at least one of a learning rate, a weight decay, a batch size, a number of convolutional layers, a number of convolutional long short-term memory cells, or a number of encoder stages.

8. The apparatus of claim 1, wherein the data handler is to:
determine a first pixel of the MCS frame is white in response to determining first samples of the first pixel corresponding to the color frame are the same color; and
determine a second pixel of the MCS frame is black in response to determining second samples of the second pixel corresponding to the color frame are not the same color.

9. An apparatus, comprising:
at least one memory;
instructions; and
at least one processor to execute the instructions to:
generate a multi-sample control surface (MCS) frame based on a color frame;
obtain features from the color frame, a depth frame, and the MCS frame;
generate spatial data and temporal data based on the features; and
generate a high-resolution image based on the features, the spatial data, and the temporal data.

10. The apparatus of claim 9, wherein the depth frame is a first depth frame, and the at least one processor is to execute the instructions to generate an object overlap frame based on a comparison between the first depth frame and a second depth frame, the second depth frame corresponding to a first time, the first time before a second time corresponding to the first depth frame.

11. The apparatus of claim 10, wherein the at least one processor is to execute the instructions to determine the spatial data and the temporal data based on the object overlap frame.

12. The apparatus of claim 9, wherein the at least one processor is to execute the instructions to determine the spatial data and the temporal data using a convolutional long short-term memory cell.

13. The apparatus of claim 9, wherein the at least one processor is to execute the instructions to:
generate encoded data by down-sampling the features, the spatial data, and the temporal data; and
up-sample the encoded data to generate the high-resolution image based on a network up-sampling scale.

14. The apparatus of claim 13, wherein the at least one processor is to execute the instructions to reduce a length of an encoder path based on the network up-sampling scale.

15. The apparatus of claim 9, wherein the at least one processor is to execute the instructions to configure one or more network design parameters, the one or more network design parameters including at least one of a learning rate, a weight decay, a batch size, a number of convolutional layers, a number of convolutional long short-term memory cells, or a number of encoder stages.

16. The apparatus of claim 9, wherein the at least one processor is to execute the instructions to:
determine a first pixel of the MCS frame is white in response to determining first samples of the first pixel corresponding to the color frame are the same color; and
determine a second pixel of the MCS frame is black in response to determining second samples of the second pixel corresponding to the color frame are not the same color.

17. At least one non-transitory computer readable medium comprising instructions that, when executed, cause at least one processor to at least:
generate a multi-sample control surface (MCS) frame based on a color frame;
obtain features from the color frame, a depth frame, and the MCS frame;
generate spatial data and temporal data based on the features; and
generate a high-resolution image based on the features, the spatial data, and the temporal data.

18. The at least one non-transitory computer readable medium of claim 17, wherein the depth frame is a first depth frame, and the instructions, when executed, cause the at least one processor to generate an object overlap frame based on a comparison between the first depth frame and a second depth frame, the second depth frame corresponding to a first time, the first time before a second time corresponding to the first depth frame.

19. The at least one non-transitory computer readable medium of claim 18, wherein the instructions, when executed, cause the at least one processor to determine the spatial data and the temporal data based on the object overlap frame.

20. The at least one non-transitory computer readable medium of claim 17, wherein the instructions, when executed, cause the at least one processor to determine the spatial data and the temporal data using a convolutional long short-term memory cell.

21. The at least one non-transitory computer readable medium of claim 17, wherein the instructions, when executed, cause the at least one processor to:
generate encoded data by down-sampling the features, the spatial data, and the temporal data; and
up-sample the encoded data to generate the high-resolution image based on a network up-sampling scale.

22. The at least one non-transitory computer readable medium of claim 21, wherein the instructions, when executed, cause the at least one processor to reduce a length of an encoder path based on the network up-sampling scale.

23. The at least one non-transitory computer readable medium of claim 17, wherein the instructions, when executed, cause the at least one processor to configure one or more network design parameters, the one or more network design parameters including at least one of a learning rate, a weight decay, a batch size, a number of convolutional layers, a number of convolutional long short-term memory cells, or a number of encoder stages.

24. The at least one non-transitory computer readable medium of claim 17, wherein the instructions, when executed, cause the at least one processor to:
determine a first pixel of the MCS frame is white in response to determining first samples of the first pixel corresponding to the color frame are the same color; and
determine a second pixel of the MCS frame is black in response to determining second samples of the second pixel corresponding to the color frame are not the same color.

25.-32.(canceled)
